(19) United States
(12) Patent Application Publication
(10) Pub. No.: US 2018/0095155 A1
(43) Pub. Date: Apr. 5, 2018

(54) Systems, methods, and apparatuses for implementing a smart beacon monitoring system

(71) Applicants: Kanishk Soni, San Jose, CA (US); Anupam Awasthi, Saratoga, CA (US); Amol Awasthi, Dubai (AE); Rabindra Chakraborty, John Creek, GA (US); Jay Kalra, San Jose, CA (US)

(72) Inventors: Kanishk Soni, San Jose, CA (US); Anupam Awasthi, Saratoga, CA (US); Amol Awasthi, Dubai (AE); Rabindra Chakraborty, John Creek, GA (US); Jay Kalra, San Jose, CA (US)

(21) Appl. No.: 15/590,945

(22) Filed: May 9, 2017

Related U.S. Application Data
(60) Provisional application No. 62/333,408, filed on May 9, 2016.

(51) Int. Cl. G01S 1/02; G08G 5/04; H04W 4/00; G08G 5/00; G01S 1/04; H04L 29/08

(52) U.S. Cl. CPC G01S 1/024; G08G 5/045; H04W 4/006; G01S 2013/916; G01S 1/042; H04L 67/12; H04L 67/10; G08G 5/0047

(57) ABSTRACT

In accordance with disclosed embodiments, there are provided systems, methods, and apparatuses for implementing a smart beacon monitoring system supported by a processor and a memory to execute such functionality. For instance, in accordance with one embodiment there is an Internet of Things (IOT) beacon, which includes: a light source; a Remote Transmission Unit (RTU) to communicate with a remote centralized communication station over a network; a plurality of sensors, each to collect telemetry data at the IOT beacon; in which the RTU is to transmit the collected telemetry data from the plurality of sensors to the remote centralized communication station over the network for analysis; in which the remote centralized communication station is to identify a current or predicted failure condition at the IOT beacon based on the analysis of the collected telemetry data from the plurality of sensors; and in which the remote centralized communication station is to initiate one or more alerts to have service personnel perform maintenance to correct the identified current or predicted failure condition at the IOT beacon. Other related embodiments are disclosed.

### CLAIM OF PRIORITY

This non-provisional utility patent application is related to and claims priority to the U.S. Provisional application entitled “SMART BEACON MONITORING SYSTEM,” filed on May 9, 2016, having a U.S. Provisional patent application No. 62/333,408, and attorney docket number 9681P004Z, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments of the invention relate generally to the field of computing, and more particularly, to systems, methods, and apparatuses for implementing a smart beacon monitoring system supported by a processor and a memory to execute such functionality. Other embodiments relate to uni-directional and bi-directional communications with a smart beacon monitoring system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

Aircraft warning lights, also referred to as “beacons,” are generally high-intensity lighting devices attached to tall structures which are employed as collision avoidance measures. Such devices make the structures to which they are attached more readily visible to passing aircraft and are usually used at night, although they may be used during the day as well. Such beacons must be of sufficient brightness so as to be visible for miles surrounding the structure to which they are attached.

Such beacons are generally attached to tall structures such as broadcast masts and towers, water tanks located on high elevation, electricity pylons, chimneys, tall buildings, cranes and wind turbines. Shorter structures located near airports may also require the use of a beacon, such as with the scoreboard at Lambeau Field in Green Bay, Wis. built in 2013, which is the tallest structure in the general area of nearby Austin Straubel International Airport. The International Civil Aviation Organization (ICAO) sets standards for the performance and characteristics of aviation warning lamps which such standards usually being adopted worldwide.

Typical lighting configurations include clusters of two or more lights or beacons around a structure at specific heights on the tower. Frequently there are beacons at the top with additional beacons or sets of lights being equally spaced down the structure.

With literally billions of dollars worth of assets continually flying throughout the skies, including both unmanned aerial vehicles (“UAVs” or “drones”) and passenger aircraft transporting human lives day and night from one location to another, there is both a safety requirement and an economic incentive to ensure the most optimal operation of such beacons.

The present state of the art may therefore benefit from the systems, methods, and apparatuses for implementing a smart beacon monitoring system as is described herein as well as the uni-directional and bi-directional communications means utilizing such a smart beacon monitoring system.

### BRIEF DESCRIPTION OF THE DRAWINGS

Embodiments are illustrated by way of example, and not by way of limitation, and will be more fully understood with reference to the following detailed description when considered in connection with the figures in which:

FIG. 1 depicts an exemplary architecture for a remote station having a smart beacon operating therein in accordance with described embodiments.

FIG. 2A depicts another exemplary architecture for a remote station having a smart beacon operating therein in accordance with described embodiments;

FIG. 2B depicts an alternative exemplary architecture for a remote station having a smart beacon operating therein in accordance with described embodiments;

FIG. 2C depicts yet another alternative exemplary architecture for a remote station 203 having a smart beacon operating therein in accordance with described embodiments;

FIG. 3 depicts an exemplary remote station in accordance with described embodiments;

FIG. 4 depicts an exemplary centralized monitoring station operating within the cloud in accordance with described embodiments;

FIGS. 5A, 5B, and 5C illustrate flow diagrams providing methods for implementing a smart beacon monitoring system supported by a processor and a memory to execute such functionality in accordance with disclosed embodiments;

FIG. 6A shows a diagrammatic representation of an IOT beacon within which embodiments may operate, be installed, integrated, or configured;

FIG. 6B illustrates a diagrammatic representation of a machine in the exemplary form of a computer system, in accordance with one embodiment;

FIGS. 7A-7C depict a block diagram of a detailed sample architecture of a prediction engine in accordance with described embodiments; and

FIG. 8 depicts a flowchart of an exemplary process for predicting failure within a system by the prediction engine in order to generate an insight or a prediction in accordance with described embodiments.

### DETAILED DESCRIPTION

Described herein are systems, methods, and apparatuses for implementing a smart beacon monitoring system supported by a processor and a memory to execute such functionality. For instance, in accordance with one embodiment there is an Internet of Things (IOT) beacon, which includes: a light source; a Remote Transmission Unit (RTU) to communicate with a remote centralized communication station over a network; a plurality of sensors, each to collect telemetry data at the IOT beacon; in which the RTU is to transmit the collected telemetry data from the plurality of sensors to the remote centralized communication station over the network for analysis; in which the remote centralized communication station is to identify a current or predicted failure condition at the IOT beacon based on the analysis of the collected telemetry data from the plurality of sensors; and in which the remote centralized communication station is to initiate one or more alerts to have service personnel perform maintenance to correct the identified current or predicted failure condition at the IOT beacon.

In the following description, numerous specific details are set forth such as examples of specific systems, languages, components, etc., in order to provide a thorough understanding of the various embodiments. It will be apparent, however, to one skilled in the art that these specific details need not be employed to practice the embodiments disclosed herein. In other instances, well known materials or methods have not been described in detail in order to avoid unnecessarily obscuring the disclosed embodiments.

In addition to various hardware components depicted in the figures and described herein, embodiments further include various operations which are described below. The operations described in accordance with such embodiments may be performed by hardware components or may be embodied in machine-executable instructions, which may be used to cause a general-purpose or special-purpose processor programmed with the instructions to perform the operations. Alternatively, the operations may be performed by a combination of hardware and software.

Embodiments also relate to an apparatus for performing the operations disclosed herein. This apparatus may be specially constructed for the required purposes, or it may be a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, embodiments are not described with reference to any particular programming language. It will be appreciated that a variety of programming languages may be used to implement the teachings of the embodiments as described herein.

Embodiments may be provided as a computer program product, or software, that may include a machine-readable medium having stored thereon instructions, which may be used to program a computer system (or other electronic devices) to perform a process according to the disclosed embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical), etc.

Any of the disclosed embodiments may be used alone or together with one another in any combination. Although various embodiments may have been partially motivated by deficiencies with conventional techniques and approaches, some of which are described or alluded to within the specification, the embodiments need not necessarily address or solve any of these deficiencies, but rather, may address only some of the deficiencies, address none of the deficiencies, or be directed toward different deficiencies and problems which are not directly discussed.

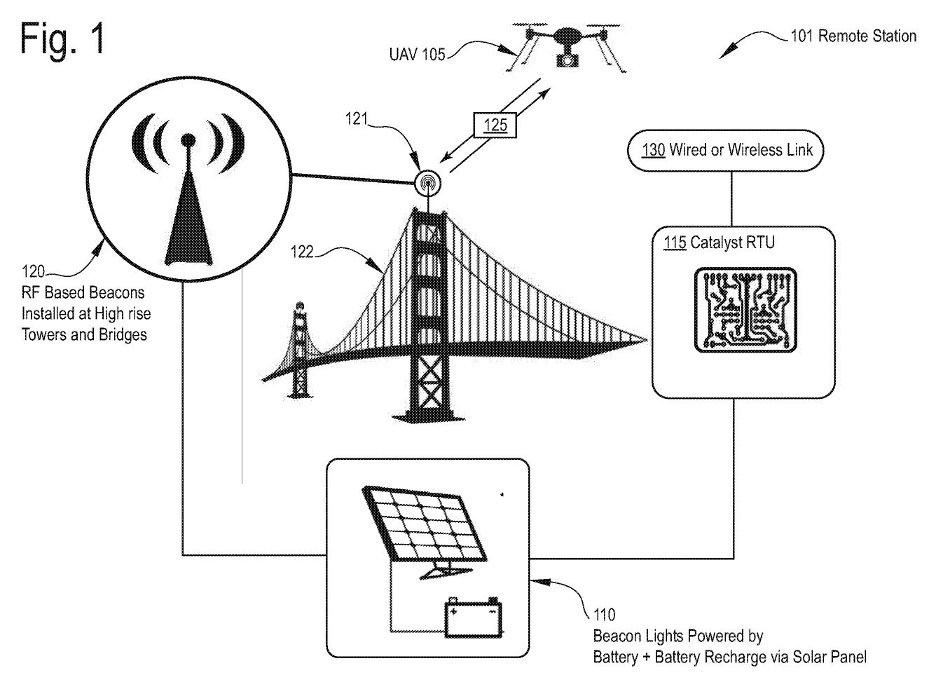

FIG. 1 depicts an exemplary architecture for a remote station 101 having a smart beacon operating therein in accordance with described embodiments.

In particular, there is depicted a smart beacon 121 positioned atop a bridge 122. The smart beacon embodies a Radio Frequency (RF) based beacon 120 which, as shown here, may be installed at any high structure such as high-rise towers, bridges, and other tall structures. Further depicted are the beacon's lights being powered by a battery 110 with the battery being rechargeable via solar power. The RF-based beacon 120 and beacon lights 110 are connected with a catalyst Remote Transmission Unit (RTU) 115 which in turn is interfaced with a wired or a wireless link 130, or both wired and wireless backhaul links returning to a centralized communication station. Lastly, there is depicted the smart beacon 121 optionally having bi-directional communication 125 or uni-directional communication with flying aircraft, such as the UAV 105 depicted here.

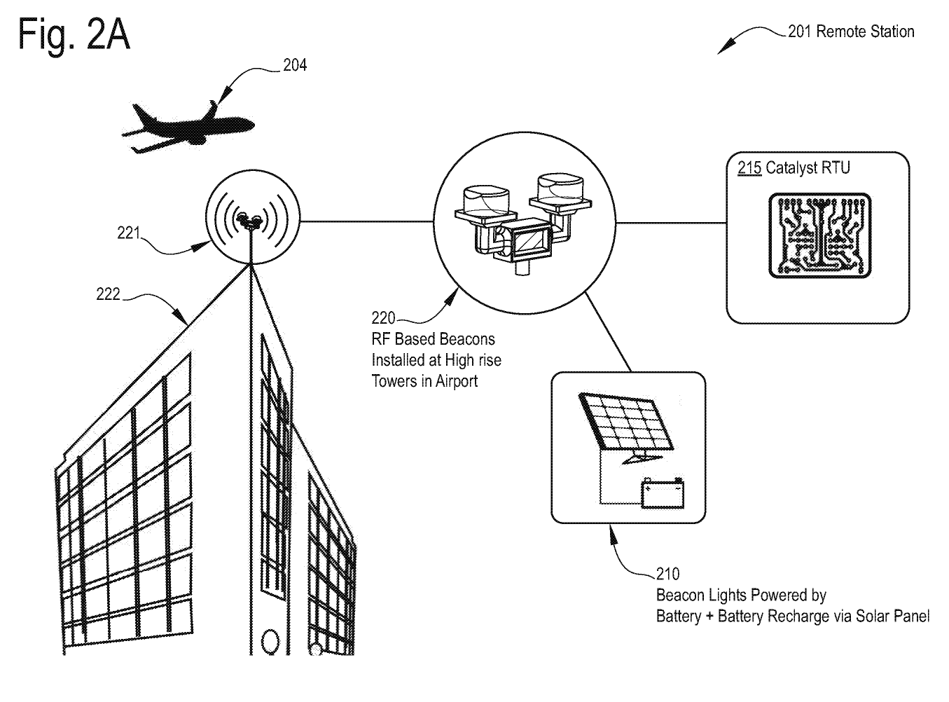

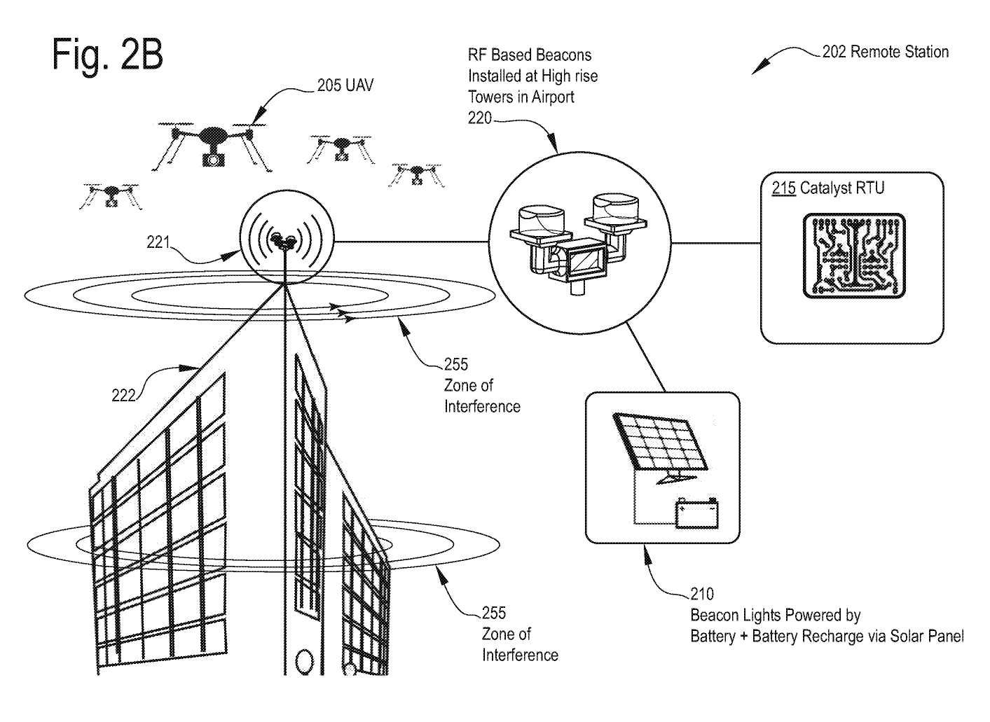

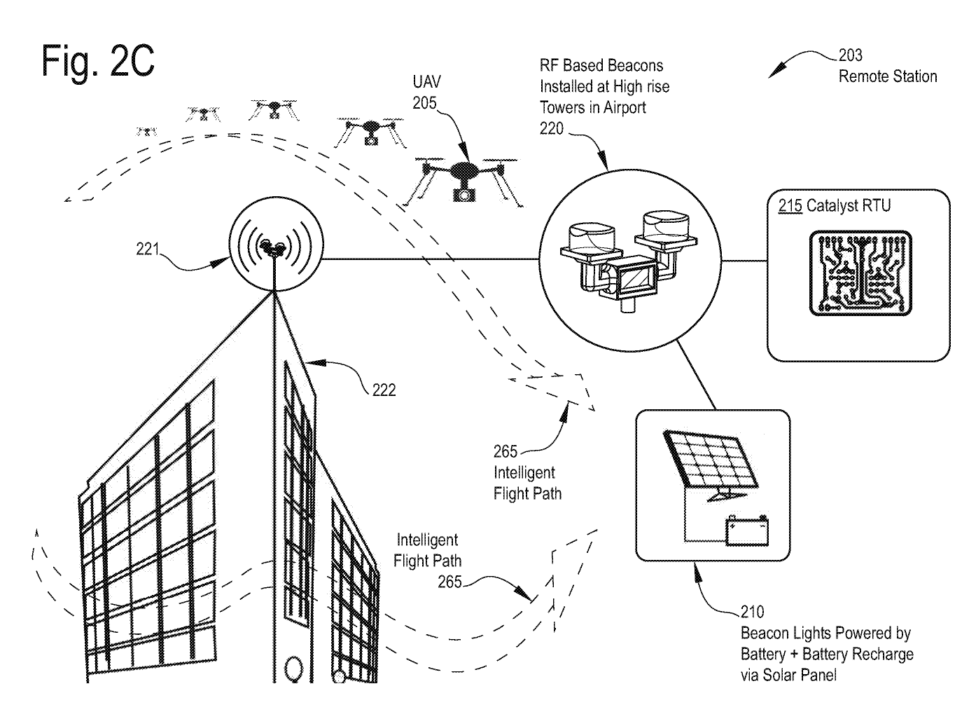

FIG. 2A depicts another exemplary architecture for a remote station 201 having a smart beacon 221 operating therein in accordance with described embodiments.

In particular, there is depicted a smart beacon 221 positioned atop a high-rise building 222. The smart beacon embodies a Radio Frequency (RF) based beacon 220 which, as shown here, may be installed at any high structure such as high-rise towers, bridges, and other tall structures. Further depicted are the beacon's lights being powered by a battery 210 with the battery being rechargeable via solar power. The RF-based beacon 220 embodies or is connected with a catalyst Remote Transmission Unit (RTU) 215 which in turn is interfaced with a wired or a wireless link, or both wired and wireless backhaul links returning to a centralized communication station. Lastly, there is depicted the smart beacon 221 optionally having bi-directional or uni-directional communication with flying aircraft 204, such as the passenger airliner depicted here.

Safety and security are critical components of an aviation system including aerial surface guidance systems which operate separately from ground staff and ground engineers. Similarly, a beacon monitoring systems provide a warning and guidance system specifically designed for aerial vehicles such as passenger, military, private, and cargo carrying aircraft 204.

Such beacons are typically installed atop high rise towers to warn aerial vehicles in case such vehicles are flying at lower altitudes, especially near airports or in the event that the structures are very tall or positioned atop naturally tall geological features, such as being positioned upon a mountain side or atop a large hillside or other natural feature.

Moreover, with the increasing use of UAVs (e.g., element 105 from FIG. 1) for the purposes of aerial photography and territorial surveillance, there is the increasing risk of collisions with buildings and towers, as well as the potential for unlawful activities via UAVs, such as industrial espionage, drug and weapon smuggling, etc.

As such safety concerns and risk of possible criminal activity increase, law enforcement, government entities, and both commercial and private security personnel have increasing concerns which must be addressed.

There is also the known problem of service and maintenance for existing light beacons provisioned in the field for the purposes of aviation safety and guidance. While light beacons are a well known technology, the conventional model by which such devices are serviced and maintained is no longer sufficient with the increasing number of deployments and the ever-present risk of aircraft and UAV collision with structures, buildings, bridges, towers, etc.

For instance, conventional solutions require that a vendor of such light beacons, as part of their service and maintenance agreements, periodically send out service personnel to the site of installation of such light beacons to check for proper functioning. Some light beacons have audible alarms or LED lights to indicate a failure mode, however, until a service person actually visits the location, the vendor and service person will be wholly unaware of any fault with the light beacon. Consequently, risk to aircraft is increased where the light beacon is failing to illuminate or is outputting insufficient light.

Upon visiting a site and identifying a failure, service personnel will repair the fault by, for example, replacing a light bulb, replacing a battery, cleaning or replacing solar panels, etc., so as to bring the light beacon back into expected functional parameters. However, such a strategy is extremely costly as the service personnel must visit every location and check for fault modes as well as slow as the beacons may fail and remain in a failed non-functional state for some time until the service personnel arrives on scene to check the functionality of the light beacon.

It is therefore in accordance with the described embodiments that the systems, methods, and apparatuses for implementing a smart beacon monitoring system is provided, as well as means for uni-directional or bi-directional communications with such a smart beacon monitoring system.

Rather than waiting for a vendor's service personnel to visit the site or schedule an engineer for on-site maintenance, which is a costly and time-consuming process, the RF-based beacon 220 (or smart beacon 221) depicted here includes both monitoring and communication components such that faults may be observed in-situ by the smart beacon's 221 components, with appropriate telemetry being communicated back to a central monitoring station in the cloud via the catalyst RTU 215. At the remote monitoring station, analytics are then applied to the collected data to determine that a fault has been monitored by the smart beacon 221 and reported back to the cloud, subsequent to which an alert may be generated and sent to a vendor, thus prompting the vendor to then send an engineer onsite to conduct a repair or any necessary maintenance. While the repair and use of the engineer or other service personnel will incur some cost, it is much more efficient to schedule repairs or prompt the vendor to conduct urgent or critical repairs rather than having the engineer or service personnel conduct needless visits to beacons which remain in a perfectly functional state.

Such cost savings are amplified when the local installation site is especially difficult, dangerous, or treacherous for the service personnel to reach, for instance, where the installation is in a foreign country from the vendor, thus requiring greater logistics and costs, or when the installation is installed on, for example, a mountainside, at the top of a radio tower, on an ocean platform, etc., all of which introduce cost, risk, and complexity for the service personnel conducting the maintenance or repair.

It is therefore in accordance with such embodiments that intelligent sensing hardware, such as a light sensor, state sensor, voltage sensor, radio transmission sensors, optical sensors, weather sensors, humidity and temperature sensors, and other sensing hardware may be embodied within the smart beacon 221 so as to enable the monitoring and identification of external conditions and events which affect the operation of the smart beacon, with such intelligent sensing hardware providing telemetry data back to the smart beacon 221 and RTU 215 which then in turn transmits the telemetry data back to a cloud service for analysis.

Due to their height, tall buildings present a hazard to the aircraft flying in the vicinity, and therefore, the beacons provide guidance and obstacle avoidance to the aircraft via the red-light illuminated at the top of such buildings, emitted from the beacons.

The smart beacons provide an IOT (Internet Of Things) enabled lumen control which is network interfaced to a cloud-based service. The smart beacons are therefore manageable from a remote centralized monitoring service including control of such beacons and monitoring the beacons to detect faults or even predict the likelihood that a fault may occur.

For instance, with such a system, if the brightness decreases, a light sensor at the smart beacon will detect the decrease in luminosity ahead of time and may then determine the reason for the decrease in brightness. Such fault conditions may be attributable to dusty or dirty solar panels, an expired battery which is no longer capable of holding its charge or providing sufficient current, a faulty bulb, and so forth. For instance, solar panels operating at high altitudes atop buildings, towers, and mountainsides may become dusted over thus degrading the surface condition for the solar panel which inhibits the solar panel's ability to generate a correct amount of voltage which then in turn leads to an inability to maintain and emit sufficient luminosity.

Utilizing sensors, such as a light sensor provisioned with the smart beacon, it is possible to observe that either the luminosity has suddenly fallen below a threshold amount, indicating a critical failure requiring urgent servicing or alternatively, that luminosity is trending downwards over time, and therefore, an analytical engine processing telemetry data received from the smart beacon can initiate an alert for non-critical servicing, even before the smart beacon reaches what would be considered a failure condition. For instance, while the present luminosity may be observed as exceeding a minimum threshold and therefore, no failure condition is present, the analytical engine may nevertheless predict that the smart beacon will fall below such a minimum threshold at a predicted time or date, thus permitting service personnel to perform non-critical routine maintenance before such a failure mode is reached.

Based on such a prediction, as well as analysis of telemetry data to evaluate the particular failure mode or predicted failure mode, the appropriate servicing personnel may then be alerted and summoned to rectify the problem. For instance, cleaners may be sent to clean the surface of the solar panels, thus restoring the smart beacon to full functionality, or alternatively, it may be necessary to alert an engineer to replace a battery or change a beacon lamp, or take other corrective action as identified and recommended by the analytical engine applied by the cloud-based smart beacon monitoring service.

FIG. 2B depicts an alternative exemplary architecture for a remote station 202 having a smart beacon 221 operating therein in accordance with described embodiments.

In particular, there is depicted a smart beacon 221 positioned atop a high-rise building 222. The smart beacon 221 or multiple smart beacons 221 working cooperatively establish a zone of interference 255 surrounding the building 222 as shown so as to disrupt communication and operation of UAVs 205 such as the small drones depicted near the building 222. As before, the smart beacon 221 embodies a Radio Frequency (RF) based beacon 220 in which the beacon's lights are powered by a battery 210 with the battery being rechargeable via solar power and further in which the RF-based beacon 220 embodies or is connected with a catalyst Remote Transmission Unit (RTU) 215 having either or both wired and wireless based backhaul links returning to a centralized communication station.

In this particular embodiment, it is not necessary for the smart beacon(s) to communicate with the UAVs as the smart beacon instead establishes the zone of interference 255 protecting the building 222. The smart beacon(s) will, however, remain in communication with a centralized communication station, for example, with a cloud computing architecture which is in communication with the RTU 215 or other RF-based communication means of the smart beacon 221 via, for instance, a transceiver embedded within or configured with the smart beacon so as to enable to the smart beacon 221 to communicate with, send information to, and receive information from, a cloud computing analytics system, storage repository, centralized communications station, etc.

According to a particular embodiment, the smart beacon 221 includes intelligent sensing hardware to monitor, observe, detect, or sense a root cause fault or failure mode at the smart beacon, for instance, bad weather, faulty light bulb, low voltage from a battery, etc.

However, other conditions are also determinable, such as the presence of unmanned aircraft such as UAVs or drones within close proximity to the building 222 or other structure upon which the smart beacon 221 is installed. As depicted here, the smart beacon's 221 intelligent sensing hardware detects the presence of the UAVs 205 within a buffer safety zone surrounding the building and responds by emitting a zone of interference, in which high power radio waves configured to interfere with normal operation of the UAVs 205 are emitted so as to cause the manually controlled aircraft or non-human controlled UAV 205 aircraft to recede from the area due to the zone of interference 255.

According to one embodiment, the smart beacon 221 detects and may additionally interact with Radio Frequency (RF) based Unmanned Aerial Vehicle (UAV) 205 via wireless detection and broadcast system circuitry embedded within the smart beacon 221.

According to another embodiment, the smart beacon 221 automates aircraft warning tower lights, which are required to be turned ON and OFF depending on the intensity of the daylight. In such an embodiment, the smart beacon's 221 intelligent sensing hardware includes both a sensor to monitor sunlight intensity and additionally includes a lumens detector to monitor the presence and intensity of light emitted by the smart beacon's 221 aircraft warning lights. The smart beacon may capture telemetry from the sensors and process the telemetry information locally to make a determination of ON or OFF state for the aircraft warning tower lights based on a pre-configured profile or may report such information to a cloud service via the RTU 215 for processing and then respond to instructions received from the cloud service via the RTU 215, in which such instructions direct the smart beacon 221 to transition the aircraft warning tower lights to either an ON or OFF state.

According to another embodiment, redundancy is provided for the remote station 202 and smart beacon 221 via an additional light system which becomes operational only upon the failure of the main or primary lighting system or when the main or primary lighting system is determined to emit insufficient or no light during normal operations. Such a determination may be detected by intelligent sensing hardware of the smart beacon's light sensor aimed at or within proximity of the smart beacon's lighting system.

According to another embodiment, the smart beacon controls an ON/OFF sequence of two high and medium intensity lamps and four low-intensity lamps based utilizing Light Dependent Resistor (LDR) output and voltage sensing of the battery. According to such embodiments, if a main lamp is faulty, then the standby lamp operates according to the day/night brightness. According to another embodiment, the smart beacon implements logic for blinking of the aircraft warning lamps and automatic ON/OFF as per day brightness. The smart beacon may implement such logic and controls pursuant to the instruction of a cloud-based service in communication with the smart beacon or pursuant to a pre-configured profile available locally at the smart beacon.

According to another embodiment, the smart beacon includes sensors to monitor and report one or more of: per-lamp ON/OFF status, battery voltage, charging and discharging states and voltages, luminosity emissions, etc. According to such embodiments, telemetry data is measured and calculated locally at the smart beacon utilizing a microcontroller or processor and memory local to the smart beacon to deduce any alarm or fault condition which is then reported to the cloud service. In alternative embodiments, the telemetry data is captured locally at the smart beacon and then uploaded to the cloud service for analysis and fault condition determination.

Regardless of how the fault is determined, upon identification of a fault within any smart beacon, an alert will then be triggered so as to provide notification to appropriate personnel. For instance, such alerts may be issued to a centralized server which then broadcasts the message in the form of email or SMS to appropriate parties.

While the need for collision avoidance of manned aircraft is well known, the problems and risks posed by new technology is lesser understood and has not yet been adequately addressed. For instance, in a congested downtown area, there may be numerous unmanned drones or UAVs flying throughout the area day and night. Such UAVs pose not only a collision risk to buildings, but a risk of harm to those on the ground in the event a drone collides with a building and falls, as well as a potential security risk to private, public, and governmental buildings as such drones carry with them surveillance equipment capable of capturing video and audio.

Therefore, it is in accordance with described embodiments that any drone entering a given radius or coming within a prescribed distance of a building having a smart beacon attached will manage the drone or UAV so as to avoid a collision.

While many drones have object detection functionality and are fully capable of avoiding collisions with large buildings, the technology on such drones very often is incapable of avoiding a structure with significant negative space, such as is the case with a tower or lattice structure. Similarly, a simple rod, such as a tall flag pole or antenna protruding from a building may not be detected by the drone and therefore poses a collision risk. Still further, if the drone is being manually controlled by a human operator there is similarly a risk of collision due to insufficient skill on the part of the operator or other human error by the operator which may result in a collision.

Therefore, the smart beacons according to certain embodiments emit radio waves which serve as a signal jamming signal or sonic waves or ultrasonic waves or pulsed high pressure air bursts as a deterrent and a disruptive force to the drones so as to create the zone of interference 255 around the building or tower or antenna which will then in turn cause a self-navigating or autonomous UAV to turn back or select an alternate course or cause a human operator to retreat due to the interference with flight controls as cause by the air bursts or the radio, sonic, or ultrasonic waves.

FIG. 2C depicts yet another alternative exemplary architecture for a remote station 203 having a smart beacon 221 operating therein in accordance with described embodiments.

In particular, there is depicted a smart beacon 221 positioned atop a high-rise building 222. The smart beacon 221 or multiple smart beacons 221 working cooperatively establish intelligent flight paths 265 via which drones and UAVs 205 may safely navigate around an obstacle, such as the building 222 or via which the drones and UAVs 205 may safely remain a safe distance from the building 222 under the direction of the smart beacon 221. As before, the smart beacon 221 embodies a Radio Frequency (RF) based beacon 220 in which the beacon's lights are powered by a battery 210 with the battery being rechargeable via solar power and further in which the RF-based beacon 220 embodies or is connected with a catalyst Remote Transmission Unit (RTU) 215 having either or both wired and wireless based backhaul links returning to a centralized communication station.

In this particular embodiment, the smart beacon(s) establish at least uni-directional communications with the UAVs instructing such drones and UAVs 205 to traverse an intelligent flight path 265 as established by the smart beacon 221 so as to ensure the drones and UAVs 205 do not collide with the building 222 and additionally so as to ensure the as the smart beacon instead establishes the zone of interference 255 protecting the building 222. The smart drones and UAVs 205 maintain a safe distance from the building, such as by remaining outside of a safety buffer surrounding the building 222.

In certain embodiments, the zone of interference 255 from FIG. 2B may be combined with the implantation of an intelligent flight path 265 as depicted here so as to permit drones and UAVs 205 to safely navigate around the building 222 by traversing the intelligent flight path 265 established by the smart drone 205 while providing additional protection to the building 222 through the use of the zone of interference 255 surrounding the building 222 in the event drones and UAVs 205 violate the established intelligent flight path 265 or navigate within a safety buffer, such as that established by the zone of interference 255 surrounding the building 222. In such embodiments, drones and UAVs 205 may, when configured, receive instructions and communications from the smart beacon 221 and avoid colliding with the building, but nevertheless be subjected to communications disruption if the drones and UAVs 205 fly too near to the building.

For instance, drones and UAVs 205 under manual control may be configured to receive such instructions from the smart beacon 221, yet due to manual control, nevertheless violate the safety buffer around the building due to a human operator's refusal to comply at which point communications between the drones and UAVs 205 and the human operator(s) will be subjected to communication disruptions within the zone of interference 255 from FIG. 2B.

Currently the FAA is passing a variety of regulations pertaining to the operation of drones which exceed a specified weight limit and/or operate above a certain height from the ground. In the future, there may be structured pathways for such UAVs to navigate throughout a densely populated area, however, such regulations simply are not yet in place and likely will not be in place for many years.

Meanwhile, the presence of drones continues to increase at a very fast rate and it is commonplace for drones and UAVs to be observed in both cities and rural areas.

The lack of effective regulation in no way diminishes the risk posed by such drones to buildings, and therefore, it is in accordance with certain described embodiments that the smart beacons establish an intelligent flight path around the buildings, towers, antennas, or other structures to which they are attached, so as to avoid a collision and additionally so as to permit the drones to navigate the area in a manner suitable to the parties responsible for the structure to which the smart beacon is attached.

For instance, the smart beacon may establish an intelligent path around a building or other structure which requires the UAVs or drones to maintain a given distance from the structure, or traverse a designated route in a specified direction or at a specified altitude, and so forth.

In such a way, it is possible for the smart beacon to establish an effective boundary around a given property or asset with the smart beacon detecting such drones (e.g., through radio, optical, audible detection, etc.) and instructing the UAVs or drones to navigate the intelligent flight path 265 established by the smart beacon. Those drones that violate such a space and enter safety buffer or cross the established boundary around the property or asset may then be subjected to interference and countermeasures by the smart beacon which will attempt to cause the UAV or drone to maintain a configured distance for the purposes of avoiding collisions and also ensuring the privacy and security of the property or asset in question.

In support of the intelligent flight path 265 the smart beacon may communicate with the drones or UAV via infrared, radio signal, or another established uni-directional protocol permitting instructions to be communicated from the smart beacon to the drone where the instructions to follow the intelligent flight path are received and executed. In certain embodiments bi-directional communications are supported between the smart beacon and the UAV or drones permitting the drones to identify themselves to the smart beacon, as well as potentially authenticate and request various clearances and permissions not granted to other UAV or drones. For instance, it is feasible that security officers for the building, structure, or property themselves employ surveillance drones to protect the property, effectively operating as flying and mobile camera units, and such drones may be in bi-directional communication with the smart beacon such that the security drones may fly within the zone of interference without being subjected to countermeasures and without being forced to navigate the intelligent flight path established by the smart beacon for other unknown or non-authenticated drones.

According to a particular embodiment, where the drones or UAVs engage in bi-directional communication, they may authenticate with the RTU of the smart beacon by utilizing an embedded security key within the CPU or circuitry of the drone. When the security key of the drone matches an expected and registered security key, the drone may operate within the vicinity of the building 222 or other structure without being forced to follow the intelligent flight path 265 and without being subjected to counter measures by the smart beacon. For instance, security drones providing surveillance around the building or other structure may reside within a buffer safety zone of the building and by authenticating with the smart beacon, prevent the smart beacon from attempting to force them out of the area, as they security drones provide a known and desirable layer of protection for the building's security personnel.

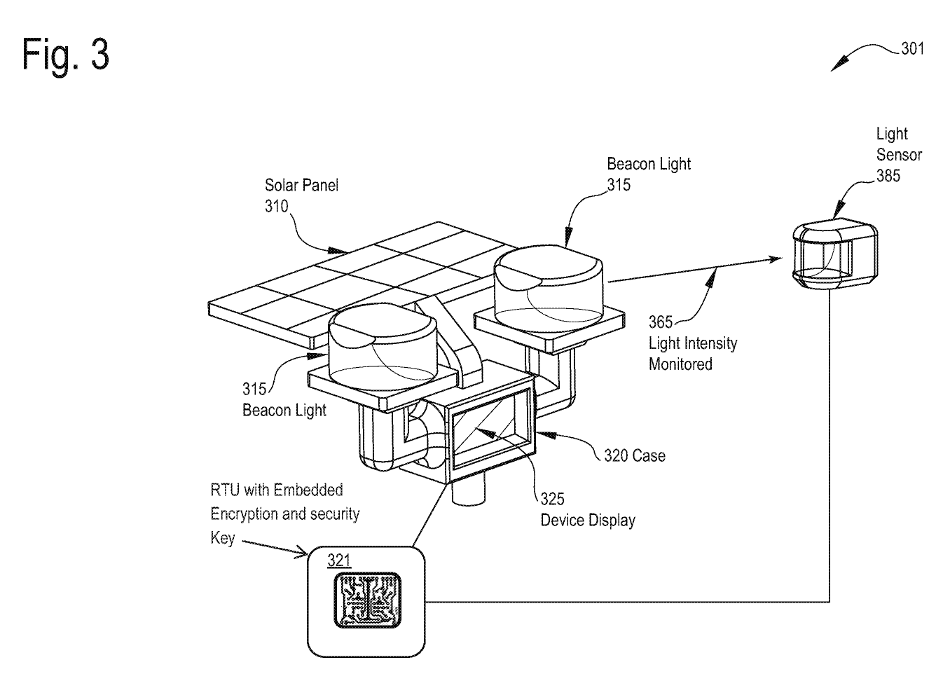

FIG. 3 depicts an exemplary remote station 301 in accordance with described embodiments.

In particular, the remote station 301 is now depicted in greater detail in which the various peripheral components, some of which are optional, may be observed. For example, there is provided a solar panel 310 via which the remote station 301 may generate electricity to power its various components as well as re-charge batteries to enable operation during non-sunlight hours. The remote station 301 may additionally have a wired power source which operates as a primary or secondary/failover power source depending upon the chosen configuration. Additionally depicted here are beacon lights 315, in which the remote station 301 implementing such a smart beacon may be configured to utilize one beacon light 315 with the other beacon light 315 operating as a backup or failover beacon light or alternatively may operate both beacon lights 315. It is also feasible to have a cluster of beacon lights 315 with more than two individual lights or a single beacon light 315, which will typically be provisioned with a special fail-safe light bulb having a secondary fail-over filament such that the beacon light 315 may continue to operate despite a primary light failure.

Further depicted within the case 320 of the remote station 301 is a display device 325 within the case 320 of the smart beacon providing an information display readout locally to the smart beacon, for instance, providing status, configuration information, failure information, etc. There may additionally be audible alarms or speakers capable of producing audible alarms provisioned with the smart beacon.

Still further shown here is an RTU 321 which provides connectivity for the remote station 301 with a centralized monitoring station, for instance, establishing cloud connectivity to the smart beacon as well as a light sensor 385 capable of monitoring the light intensity 365 output at any given time by the beacon lights 315 of the smart beacon. Telemetry data, such as lumens output by the lights, may thus be transmitted by the RTU 321 back to a remote centralized monitoring station without necessitating a service person to be locally present at the smart beacon.

With the threat of Cyberterrorism being an ever present and increasing concern, it is necessary to protect the aviation warning and collision guidance systems from potential hacking and thus, it is in accordance with described embodiments that the smart beacons and remote stations as well as the remote centralized monitoring station which provides the cloud based smart beacon monitoring services employ a variety of security protocols to avert any potential for hacking.

Generally speaking, Cyberterrorism is the use of the Internet to conduct violent acts that result in or threaten the loss of life or significant bodily harm, very often with the aim of achieving political gains through intimidation. Cyberterrorism is also sometimes considered the act of Internet terrorism in terrorist activities, including acts of deliberate, large-scale disruption of computer networks, especially of personal computers attached to the Internet, by the means of tools such as computer viruses.

Cyberterrorism is sometimes defined narrowly to relate only to deployments, by known terrorist organizations, of disruption attacks against information systems for the primary purpose of creating alarm and panic. While in other instances, the term is defined very broadly so as to include cybercrime. Regardless of the term, cyberterrorism or cybercrime, both issues are of critical concern and security measures must be implemented to protect critical infrastructure, such as the beacons utilized for aviation warning and collision avoidance, from malicious acts.

Consider for instance a passenger flight during the middle of the night traversing cross-country. Due to the darkness, visibility is extremely limited and the pilots rely generally on in-cockpit flight telemetry data. Consider, however, the possibility that the cockpit systems are compromised, in which false GPS data is provided to the flight controls and the in-cockpit telemetry displays a correct and expected flight path while the aircraft is deviated off-course, either toward a different destination or toward a potential hazard in an attempt to crash the aircraft. Because the beacons may be observed for miles, even at night and in poor weather conditions, they provide a failsafe system that the pilots routinely utilize to validate their location, orientation, altitude, etc. If the beacons were also compromised, even by simply turning them off when they are meant to be on, then such a failsafe is removed. However, by instituting appropriate security measures, the smart beacons may be ensured to operate not just with greater efficiency and up-time as discussed above, but remain operational even in the event of a purposeful cyber-terrorist attack or other hacking event.

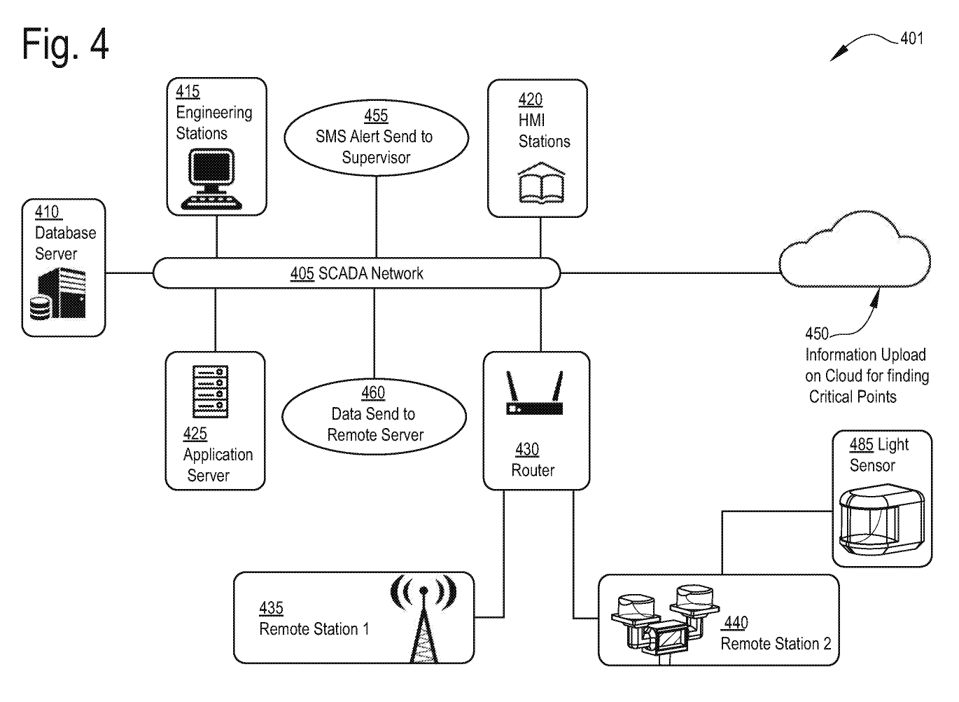

In is therefore in a accordance with a particular embodiment, the RTU 321 of the smart beacon or remote station includes an embedded encryption and security key. Such a key may be, for instance, burned into the CPU (e.g., flashed or permanently burned into registers, etc.) or other circuitry of the RTU 321 by the manufacturer such that the RTU is uniquely and unchangeably identifiable to the remote centralized monitoring station which provides the cloud based smart beacon monitoring service (e.g., as depicted in greater detail at FIG. 4). In such an embodiment, the RTU 321 engages in encrypted communication with the remote centralized monitoring station such that any communications sent to the remote centralized monitoring station are encrypted and any communications received by the RTU 321 from the remote centralized monitoring station are likewise encrypted. Moreover, the RTU 321 utilizes the embedded security key to authenticate with the remote centralized monitoring station such that the embedded security key must be provided to the remote centralized monitoring station with any provided telemetry or request for services by the smart beacon (e.g., such as a request for emergency or non-critical maintenance).

In such a way, potential cyber terrorism threats may be averted as it is not possible to alter the embedded security key via software or firmware in the event of an attempted hack of the smart beacon. Further still, physical manipulation of the smart beacon, such as replacing the smart beacon with a compromised device in an effort to perform a man in the middle type of attack will likewise fail as the compromised device will not have the proper embedded security key and will therefore be unable to authenticate with the remote centralized monitoring station. Still further, tampering of the smart beacon will trigger alarms with the remote centralized monitoring station due to unexpected telemetry results as will the failure of the properly authenticated smart beacon to communicate with and check in with the remote centralized monitoring station on a timely basis. In other related embodiments, multi-factor authentication as further utilized to supplement the use of the embedded security key, such as GPS location data requiring that the smart beacon not only provide the correct security key matching an expected security key for authentication at the remote centralized monitoring station but additionally that the smart beacon be physically present within a small localized geographic region as per requested GPS coordinates, thus making a potential cyber-terrorism hack even more impractical.

According to one embodiment, an existing and previously deployed system is upgraded to include the following functional components or a new system is provisioned with the following functional components: a service lamp ON/Fail Indication and failure via relay NO/NC type; a photocell (LDR) ON/Fail Indication and failure via relay NO/NC type; a power failure via relay NO/NC type; a standby lamp ON/Fail Indication and failure via relay NO/NC type; optionally an audible buzzer may be removed or retained as well as an LCD circuit and read out may be removed or retained; two Low Intensity (2LI) type service lamp with controlling and sensing functionality within the smart beacon's circuitry, solar cell and battery health monitoring sub-system to monitor power (e.g., batteries) at multiple locations.

As depicted here, the smart beacon system utilizes so called “plug and play” type modular hardware components and includes the following functional components: battery output voltage sensing circuitry, battery low voltage alarms and indicators; solar cell output voltage sensing circuitry; battery charging circuit and state monitoring circuitry; battery health evaluation software; and SMS and e-mail-based alarm triggering and transmission functionality. Such SMS and email-based alarm functionality includes the functionality for capturing real-time alerts and provides plug-n-play type GSM modem integration with existing hardware previously deployed or provisioned into the field. Further functionality includes the ability to register mobile numbers in software; configure the real-time alarms via SMS messaging for registered users; maintaining a record of all SMS and emails sent or attempted to send but failed; customer upgradable and configurable email alert system in which any emails sent are configurable by an administrator with corresponding data logs being maintained within an application server which resides within a connected cloud-based service platform which implements a cloud accessible web-based monitoring system for the smart beacons and their various components and circuitry.

FIG. 4 depicts an exemplary centralized monitoring station 401 operating within the cloud in accordance with described embodiments.

For instance, there is depicted here two distinct remote stations, including remote station 1 at element 435 and remote station 2 at element 440, each of which are communicably interfaced with SCADA network 405 through router 430. For instance, communications with the SCADA network 405 may be established for the remote stations via the router over a hardwired or WiFi backhaul or may alternatively communicate with cell towers over, for example, GSM, 3G, 4G, LTE, or other digital cellular communication standards.

A SCADA network 405 or a “Supervisory Control And Data Acquisition” network is a type of control system architecture utilizing computers, networked data communications and graphical user interfaces for high-level process supervisory management, in which other peripheral devices, such as the remote stations 435 and 440, programmable logic controllers, and discrete PID controllers (Proportional-Integral-Derivative controllers), provide additional functional interfaces to enable monitoring and the issuance of process commands, such as controller set point changes, etc. According to such embodiments, the receiving and transmission or issuance of such process commands are managed through the SCADA supervisory computer system while real-time control logic or controller calculations are performed by networked modules which connect to the field sensors and actuators, such as the light sensor 485 and RTUs of the remote stations 435 and 440 in the field.

A SCADA network provides a universal means of remote access to a variety of local control modules, any of which may be from different manufacturers, thus allowing access through standard automation protocols and are capable of controlling large-scale processes that can include multiple sites, such as a vast array of provisioned smart beacons which operate across large geographic distances and regions.

Further depicted is the cloud-based information upload 450 via which RTUs of the remote stations 435 and 440 may upload information to the cloud for finding and identifying critical points, such as monitored smart beacons requiring service, for instance, to replace a light, etc. The remote stations 435 and 440 which embody such smart beacons are enabled to transmit data or send data to the remote servers 460 via the SCADA network 405, with such information once received within the cloud via information upload 450 then being subjected to data analytics, for instance, via the application server 425 based on newly received information or previously received information and algorithms as stored within the database server 410. Depending upon the severity of any fault or incident, a variety of actions may be triggered, including display to engineering stations 415 for further review, automated triggering of SMS alerts sent to a supervisor 455 or display to an HMI (Human Machine Interface) station 420 where service personnel may receive and service incidents. For example, such an HMI station 420 may be displayed upon a smartphone or tablet of a service personnel out in the field having the necessary tools and training to locate and repair or service a smart beacon based on the alert.

Such information may be communicated to an exemplary cloud computing repository in fulfillment of the information upload to the cloud 450 over a public Internet. For instance, such communications may take place via any one of: a 3G cellular wireless connection; a 4G cellular wireless connection; an LTE cellular wireless connection; a GSM cellular wireless connection; a CDMA cellular wireless connection, a WiFi wireless connection, or a wired Ethernet or other wired network backhaul to the SCADA network 405 via the cloud 450.

According to a particular embodiment, the remote stations 435 and 440 communicate with a remote centralized monitoring station via the SCADA network 405, in which such a remote centralized monitoring station provides a cloud computing architecture providing cloud-based services. According to such an embodiment, the cloud computing architecture 450 initiates different events based upon the criticality of events as determined and analyzed via the application server 425 connected with the SCADA network 405.

According to described embodiments, a cloud accessible web-based monitoring system provides a user interface (UI) portal through which users may receive alerts, configure alarms and thresholds, check status of all monitored smart beacons, check telemetry reports by monitored smart beacons, retrieve and review historical reports and trend data (e.g., for site wise daily, monthly, yearly, or seasonal reporting periods, etc.). Such information may further be accessed by the user through a group dashboard which provides 24×7 availability of per-smart beacon status including lamp status and any failure modes.

By utilizing the secured cloud storage mechanism at database server 410, all alarm data and historical data are persistently stored and may be retrieved at any future date for cross checking of any past failures, performing trending analysis, audits, performing predictive and preventative maintenance via an analytical engine based on past performance of a given smart beacon or performance of similarly configured or similarly located beacons at a particular site, etc.

The user interface portals are subject to security and authentication protocols such as username/password, token, two-factor authentication, and so forth so as to ensure only properly authenticated and trusted users have access.

An analytical engine executed by the application server 425 may ingest real-time data uploaded to the cloud service (e.g., as received at the SCADA network 405) from the smart beacons deployed into the field, with the analytical engine performing data filtering and data cleansing followed by adaptable detection pursuant to customizable rule configurations which then detect and identify any critical points within the system of smart beacons or remote stations from either a safety, security, or operational concern. For instance, a UAV too near a building may be as critical as a faulty smart beacon lamp depending upon the particular implementation and configuration.

The SCADA network 405 may issue instructions to perform automated lamp switching (e.g., ON and OFF) during appropriate daytime and night operational hours which then provides a simple and hassle free means by which to operate the lamps system wide without the cost of human operators, reduces lamp burn hours which reduces maintenance and lamp replacement costs as well as reducing electrical consumption, and in turn increasing ROI where such embodiments are practiced.

Because an entire system may be monitored for faults rather than having to send engineers or service personnel to physical visit and review functionality on-site, maintenance costs are further reduced.

According to a particular embodiment, the remote stations 435 and 440 (e.g., smart beacons) undergo remote real-time monitoring by a cloud-based service, in which the cloud-based service monitors the smart beacon on a continuous basis to determine current luminous intensity (LUX) of a light at the smart beacon utilizing Light Dependent Resistor (LDR) sensors and when a luminous intensity level emitted by the light is below a pre-determined threshold (e.g., 30% or 50% or 6000 lumens, etc.) then an analysis engine of the cloud-based service triggers an alert by, for instance, sending text messages and e-mails to a supervisor's mobile device, or alerting messages to engineering station(s) or posting notifications to a interface accessible by service personnel, and so forth.

For instance, measured lumens from each of the remote stations may be monitored and compared with known standard lumens to determine whether they are degrading, and if they are degrading, if they are degrading exponentially or at an unexpected rate, indicative of a potential fault condition, such as dust on the solar panel or a faulty battery, or other potential problems.

A prediction engine analyzes the data and then generates an alert based on the results of the analysis, for instance, there may be a critical fault which requires emergency servicing or there may be a predicted fault which requires near term servicing in the next 3-5 days, etc. Such alerts are transmitted to the client based on the configuration chosen by the client in terms of contact personnel, urgency, communication means (e.g., SMS text, email, prompts via a User Interface (UI) such as at a mobile app or an engineering station, etc.).

According to a particular embodiment, the smart beacon detects a fault mode, such as emitted luminous intensity levels being below a threshold as detected by light sensor 485, and the smart beacon triggers the alert via the cloud service. In alternative embodiments, the smart beacon monitors, collects, and transmits the telemetry data to a cloud platform, such as transmitting current emitted luminous intensity levels detected by light sensor 485, and the cloud platform performs analysis and triggers the alert when necessary. For instance, such information may be uploaded to the cloud for finding and identifying critical points as depicted by element 450 with the application server 425 then performing the requisite analysis of the provided telemetry data.

According to another embodiment, UAV detection by the smart beacons or remote stations 435 and 440 may trigger an alert which is uploaded to the cloud 450 and transmitted to engineering stations 415 or broadcasted to a control room depending on the configuration for such alerts. Regardless of the alerts triggered, data uploaded to the cloud 450 may additionally be input into an analytical engine for studying the behavior analysis of the target UAV from a safety and security point of view and to potentially take corrective action, such as sending instructions to the UAV to follow an intelligent flight path to avoid the structure to which the remote stations 435 and 440 are attached or by alternatively establishing a zone of interference so as to disrupt normal operation of the UAV while in close proximity to the structure to which the remote stations 435 and 440 are attached.

The application server may execute an analysis engine and/or a prediction engine capable of isolating patterns in the telemetry data uploaded to the cloud-based service from the network of remote stations 435 and 440 or smart beacons deployed in the field and being monitored by the cloud-based service.

For instance, through the application of a series of algorithms it is possible to detect failure modes as well as predict potential failures which are likely to occur in the near future. For instance, one of the algorithms employed by a prediction engine executed by the application server 425 performs a prediction of degradation of the lumens emitted from the smart beacon so as to map the rate of degradation against a minimum operational threshold, such that service personnel may be alerted to the need to perform cleaning, maintenance, or repair based on the failure mode or predicted failure mode as determined by such a prediction engine.

For instance, if maintenance is scheduled for 2 weeks from the present date and the prediction engine identifies a potential failure mode as occurring in 48 hours or even one week, then it is possible to re-schedule and expedite the maintenance based on the prediction output by the prediction engine so as to avoid downtime for the lamp or other functionality of the remote station or smart beacon.

By knowing which remote stations or smart beacons require maintenance and servicing it is no longer necessary for an engineer or technician to visit all possible remote stations in an area to check and determine whether a fault exists, which is a hugely inefficient process as many times there will be no maintenance required. Rather than visiting hundreds or thousands of remote stations in search of an unknown problem, the service personnel may instead be alerted to the particular remote station experiencing a fault or predicted to have a fault and go directly to that location and perform the maintenance as specified by the analytics engine, thus saving significant resources and also improving overall operational efficiency of the network of remote stations as downtime will be drastically reduced or eliminated for any given remote station experiencing a fault or expected to soon incur a fault.

Because the remote stations are continuously monitored by the cloud-based service, it is also possible for the analysis engine or prediction engine executed by the application servicer 425 to immediately alert service personnel upon a critical failure which may include, for example, a period of non-communication, inability of the battery to store a charge, lumens degrading below a minimum operational threshold, a lamp failure or a lamp fail-over state, etc.

Similar to continuously monitoring luminosity so as to ensure operational compliance (e.g., lamp lumens emitted exceed a minimum threshold), it is in accordance with related embodiments that the cloud-based service additionally performs continuous monitoring of the battery health, for instance, by monitoring battery output voltage, by monitoring solar cell energy output and by measuring changes in energy capture and storage losses of the remote station or smart beacon, any and all of which may be useful to the prediction engine in predicting a potential fault condition or unsatisfactory performance of the battery, thus necessitating maintenance of the battery.

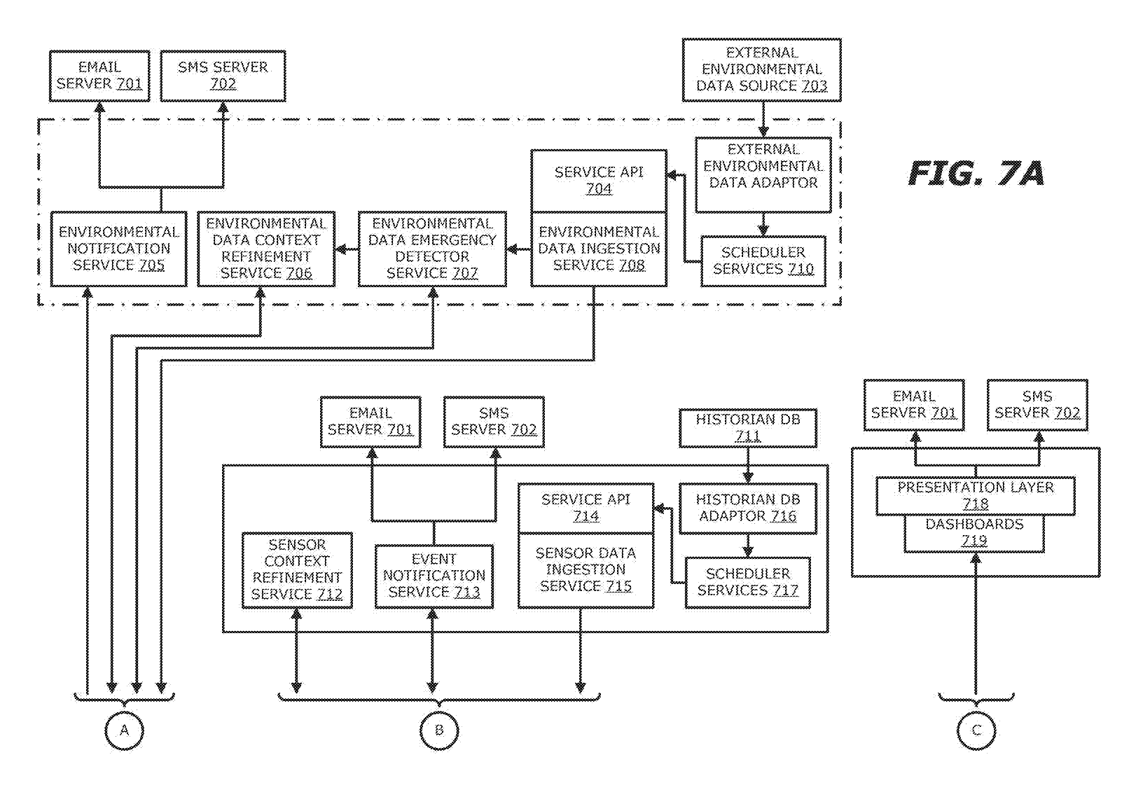

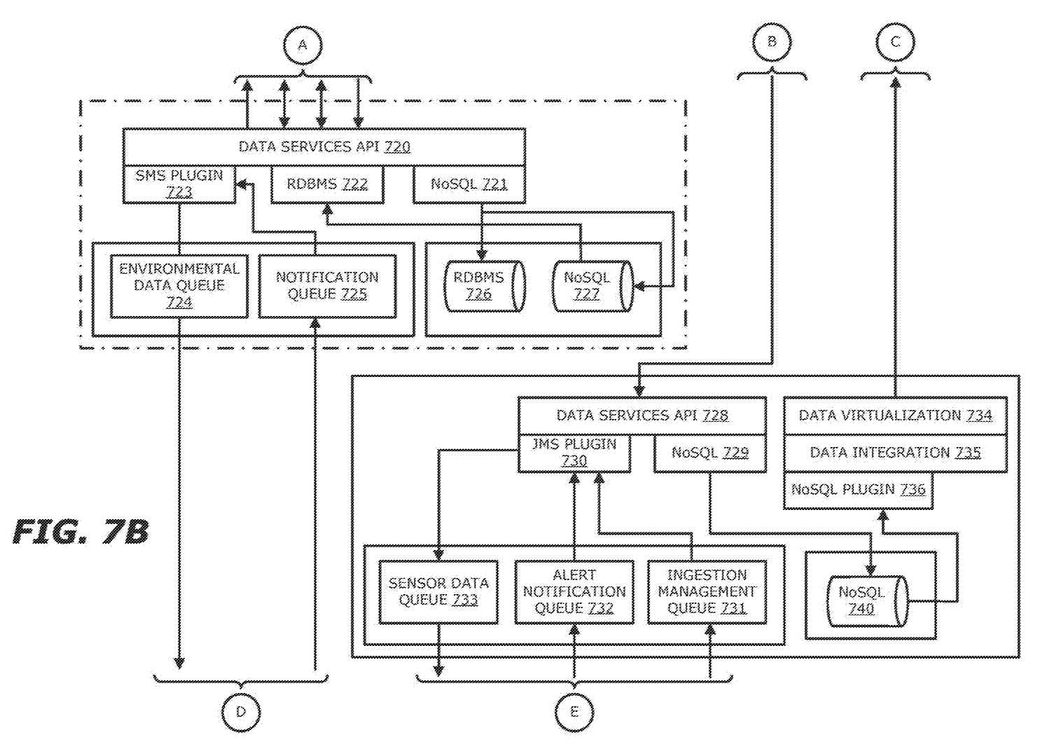

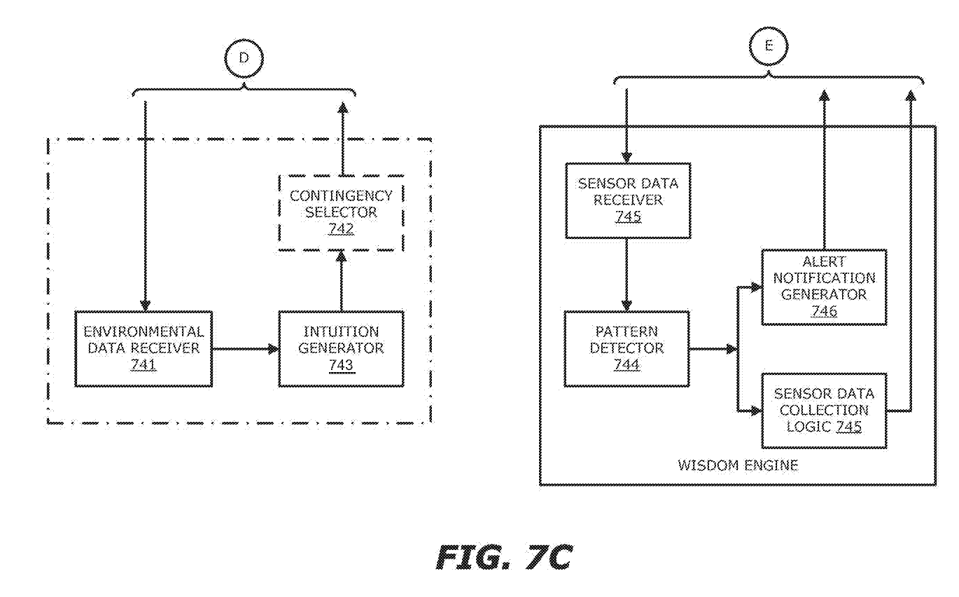

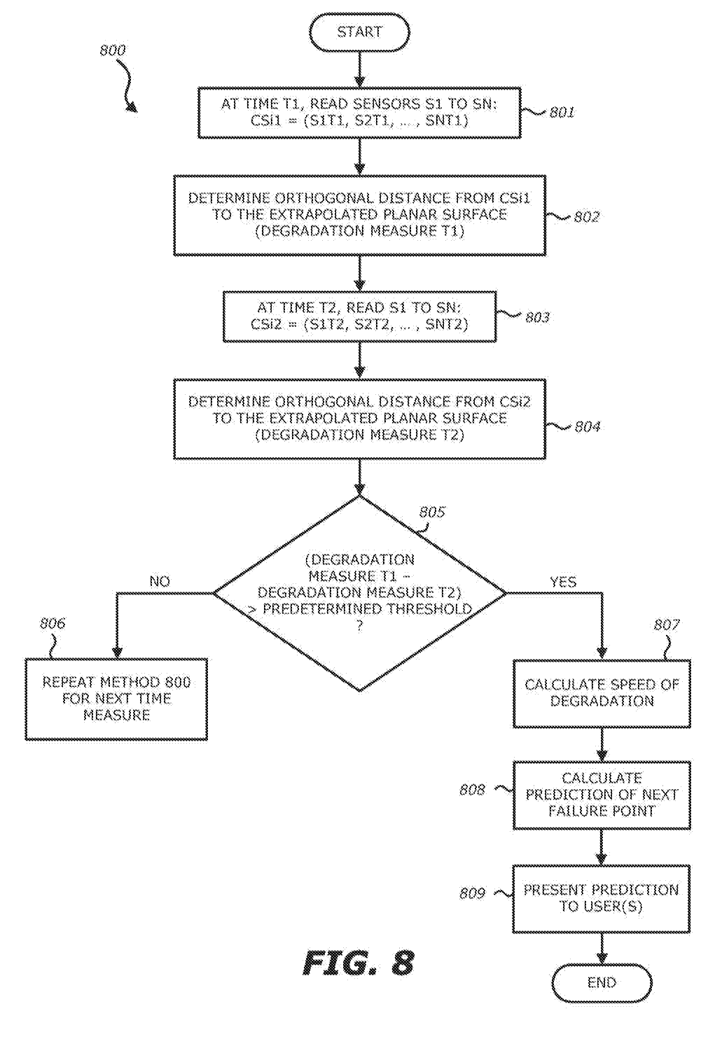

Such analysis and prediction capabilities are described in greater detail below with reference to FIGS. 7A, 7B, 7C, and FIG. 8.

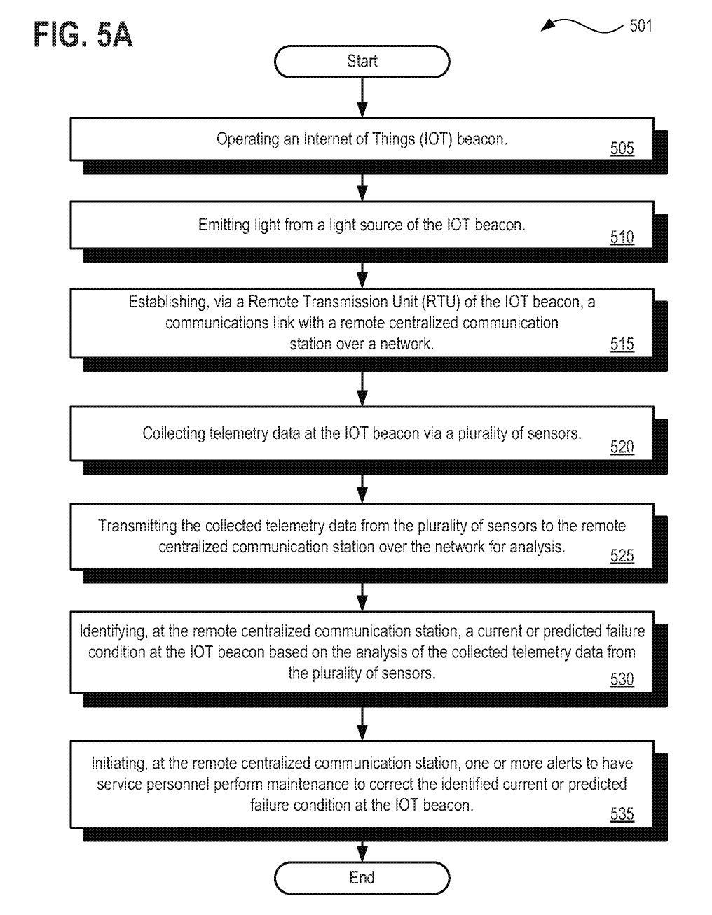

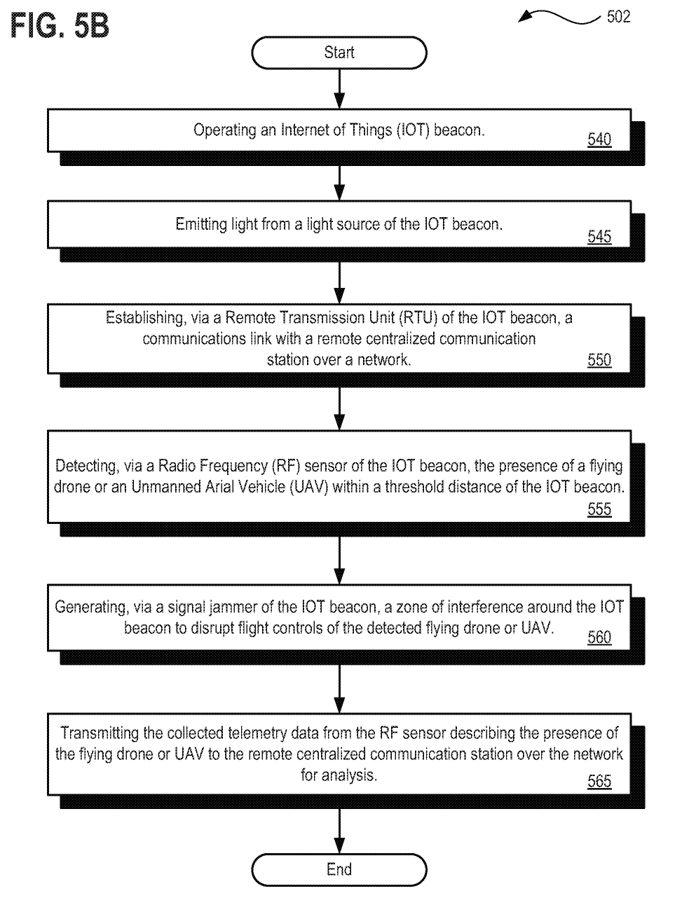

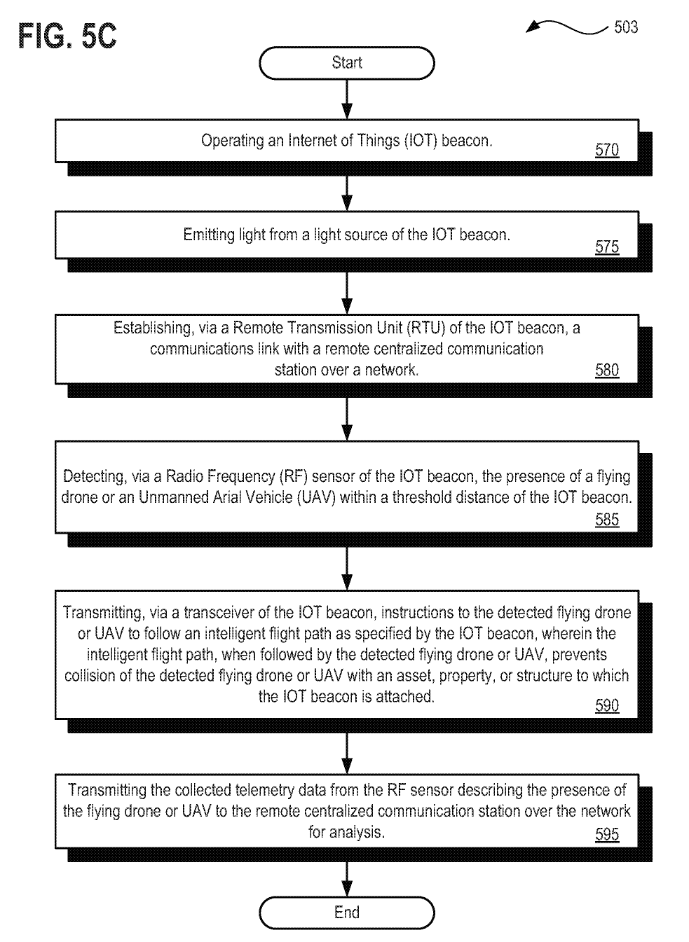

FIGS. 5A, 5B, and 5C illustrate flow diagrams providing methods 501, 502, and 503 for implementing a smart beacon monitoring system supported by a processor and a memory to execute such functionality in accordance with disclosed embodiments. Methods 501, 502, and 503 may be performed by processing logic that may include hardware (e.g., circuitry, dedicated logic, programmable logic, microcode, etc.), software (e.g., instructions run on a processing device) to perform various operations such as operating an IOT beacon, emitting, establishing, communicating, collecting, transmitting, identifying, initiating, storing records, processing, executing, providing, determining, receiving, initiating, caching, sending, returning, etc., in pursuance of the systems and methods as described herein. Some of the blocks and/or operations listed below are optional in accordance with certain embodiments. The numbering of the blocks presented is for the sake of clarity and is not intended to prescribe an order of operations in which the various blocks must occur.

With reference first to FIG. 5A, method 501 begins with block 505 for operating an Internet of Things (IOT) beacon.

At block 510, processing logic emits light from a light source of the IOT beacon.

At block 515, processing logic establishes, via a Remote Transmission Unit (RTU) of the IOT beacon, a communications link with a remote centralized communication station over a network.

At block 520, processing logic collects telemetry data at the IOT beacon via a plurality of sensors.

At block 525, processing logic transmits the collected telemetry data from the plurality of sensors to the remote centralized communication station over the network for analysis.

At block 530, processing logic identifies, at the remote centralized communication station, a current or predicted failure condition at the IOT beacon based on the analysis of the collected telemetry data from the plurality of sensors.

At block 535, processing logic initiates, at the remote centralized communication station, one or more alerts to have service personnel perform maintenance to correct the identified current or predicted failure condition at the IOT beacon.

In accordance with a particular embodiment, there is non-transitory computer readable storage media having instructions stored thereon that, when executed by a processor of an IOT beacon and/or the processor of a remote centralized communication station, the instructions cause the IOT beacon and/or the remote centralized communication station to perform operations including: operating an Internet of Things (IOT) beacon; emitting light from a light source of the IOT beacon; establishing, via a Remote Transmission Unit (RTU) of the IOT beacon, a communications link with a remote centralized communication station over a network; collecting telemetry data at the IOT beacon via a plurality of sensors; transmitting the collected telemetry data from the plurality of sensors to the remote centralized communication station over the network for analysis; identifying, at the remote centralized communication station, a current or predicted failure condition at the IOT beacon based on the analysis of the collected telemetry data from the plurality of sensors; and initiating, at the remote centralized communication station, one or more alerts to have service personnel perform maintenance to correct the identified current or predicted failure condition at the IOT beacon.

With reference next to FIG. 5B, method 502 begins with block 540 for operating an Internet of Things (IOT) beacon.

At block 545, processing logic emits light from a light source of the IOT beacon.

At block 550, processing logic establishes, via a Remote Transmission Unit (RTU) of the IOT beacon, a communications link with a remote centralized communication station over a network.

At block 555, processing logic detects, via a Radio Frequency (RF) sensor of the IOT beacon, the presence of a flying drone or an Unmanned Arial Vehicle (UAV) within a threshold distance of the IOT beacon.

At block 560, processing logic generates, via a signal jammer of the IOT beacon, a zone of interference around the IOT beacon to disrupt flight controls of the detected flying drone or UAV.

At block 565, processing logic transmits the collected telemetry data from the RF sensor describing the presence of the flying drone or UAV to the remote centralized communication station over the network for analysis.

In accordance with a particular embodiment, there is non-transitory computer readable storage media having instructions stored thereon that, when executed by a processor of an IOT beacon and/or the processor of a remote centralized communication station, the instructions cause the IOT beacon and/or the remote centralized communication station to perform operations including: operating an Internet of Things (IOT) beacon; emitting light from a light source of the IOT beacon; establishing, via a Remote Transmission Unit (RTU) of the IOT beacon, a communications link with a remote centralized communication station over a network; detecting, via a Radio Frequency (RF) sensor of the IOT beacon, the presence of a flying drone or an Unmanned Arial Vehicle (UAV) within a threshold distance of the IOT beacon; generating, via a signal jammer of the IOT beacon, a zone of interference around the IOT beacon to disrupt flight controls of the detected flying drone or UAV; and transmitting, the collected telemetry data from the RF sensor describing the presence of the flying drone or UAV to the remote centralized communication station over the network for analysis.

With reference next to FIG. 5C, method 503 begins with block 570 for operating an Internet of Things (IOT) beacon.

At block 575, processing logic emits light from a light source of the IOT beacon.

At block 580, processing logic establishes, via a Remote Transmission Unit (RTU) of the IOT beacon, a communications link with a remote centralized communication station over a network.

At block 585, processing logic detects, via a Radio Frequency (RF) sensor of the IOT beacon, the presence of a flying drone or an Unmanned Arial Vehicle (UAV) within a threshold distance of the IOT beacon.

At block 590, processing logic transmits, via a transceiver of the IOT beacon, instructions to the detected flying drone or UAV to follow an intelligent flight path as specified by the IOT beacon, wherein the intelligent flight path, when followed by the detected flying drone or UAV, prevents collision of the detected flying drone or UAV with an asset, property, or structure to which the IOT beacon is attached.

At block 595, processing logic transmits the collected telemetry data from the RF sensor describing the presence of the flying drone or UAV to the remote centralized communication station over the network for analysis.

In accordance with a particular embodiment, there is non-transitory computer readable storage media having instructions stored thereon that, when executed by a processor of an IOT beacon and/or the processor of a remote centralized communication station, the instructions cause the IOT beacon and/or the remote centralized communication station to perform operations including: operating an Internet of Things (IOT) beacon; emitting light from a light source of the IOT beacon; establishing, via a Remote Transmission Unit (RTU) of the IOT beacon, a communications link with a remote centralized communication station over a network; detecting, via a Radio Frequency (RF) sensor of the IOT beacon, the presence of a flying drone or an Unmanned Arial Vehicle (UAV) within a threshold distance of the IOT beacon; transmitting, via a transceiver of the IOT beacon, instructions to the detected flying drone or UAV to follow an intelligent flight path as specified by the IOT beacon, wherein the intelligent flight path, when followed by the detected flying drone or UAV, prevents collision of the detected flying drone or UAV with an asset, property, or structure to which the IOT beacon is attached; and transmitting, the collected telemetry data from the RF sensor describing the presence of the flying drone or UAV to the remote centralized communication station over the network for analysis.

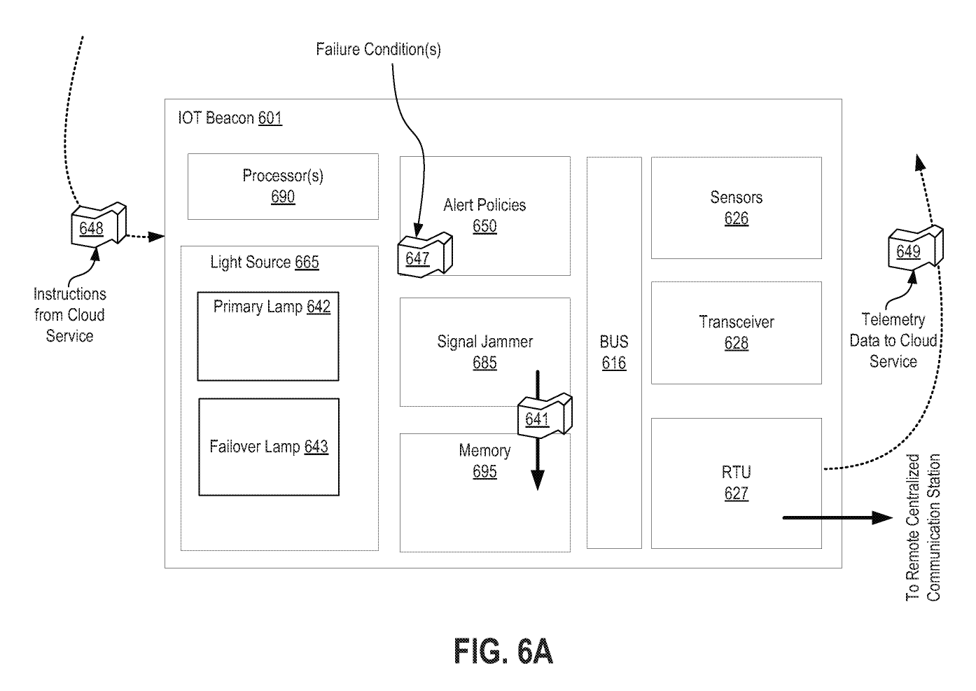

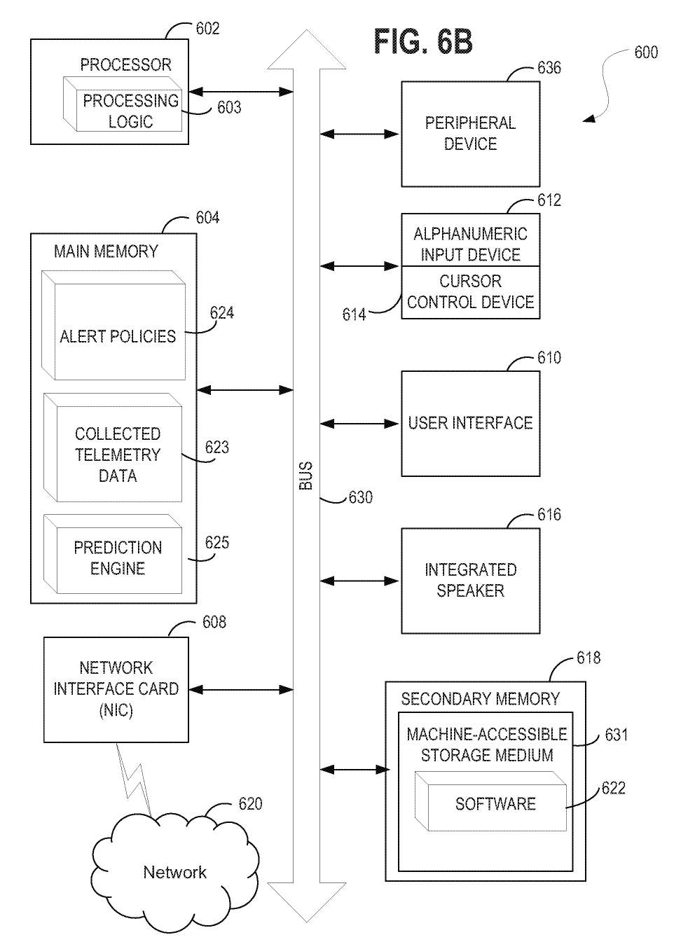

FIG. 6A shows a diagrammatic representation of an IOT beacon 601 within which embodiments may operate, be installed, integrated, or configured.

In accordance with one embodiment, there is an IOT beacon 601 having at least a processor 690 and a memory 695 therein to execute implementing logic or instructions. Such an IOT beacon 601 may communicatively interface with and cooperatively execute with the benefit of a hosted cloud computing environment, such as a cloud computing architecture or a cloud-based services provider which provides cloud-based smart beacon monitoring services. Such services may be implemented by the remote centralized communication station which is depicted as being communicably interfaced with the RTU 627 of the IOT beacon 601.

According to the depicted embodiment, the IOT beacon 601 includes a light source 665 (e.g., which may include both a primary lamp 642 and a failover lamp 643); a Remote Transmission Unit (RTU) 627 to communicate with a remote centralized communication station over a network; a plurality of sensors 626, each to collect telemetry data at the IOT beacon 601; in which the RTU 627 is to transmit the collected telemetry data 649 from the plurality of sensors to the remote centralized communication station over the network for analysis; in which the remote centralized communication station is to identify a current or predicted failure condition 647 at the IOT beacon based on the analysis of the collected telemetry data from the plurality of sensors; and in which the remote centralized communication station is to initiate one or more alerts (e.g., pursuant to configure alert policies 650) to have service personnel perform maintenance to correct the identified current or predicted failure condition at the IOT beacon 601.

Bus 616 interfaces the various components of the IOT beacon 601 amongst each other, with any other peripheral(s) of the IOT beacon 601, and with external components such as external network elements, other machines, client devices, cloud computing services, etc. Communications may further include communicating with external devices via a network interface over a LAN, WAN, or the public Internet.

According to another embodiment of the IOT beacon, the light source emits light within an aviation warning and collision avoidance system for aircraft and unmanned aerial vehicles.

According to another embodiment of the IOT beacon, the IOT beacon is attached to one of: a communication tower; a high-rise building; an antenna; a bridge; a geological feature.

According to another embodiment of the IOT beacon, the plurality of sensors to collect telemetry data at the IOT beacon include one or more of: a luminosity sensor to measure light output from the light source; a battery voltage sensor; a solar panel output voltage sensor; a weather sensor; a Radio Frequency (RF) sensor to count each time a drone or Unmanned Arial Vehicle (UAV) comes within range of the RF sensor of the IOT beacon; a thermometer to measure ambient temperature; a sunlight intensity sensor; and an embedded encryption and security key to enable encrypted security and secure authentication between the IOT beacon and the centralized communication station prior to the IOT beacon transmitting the telemetry data to the centralized communication station.

According to another embodiment of the IOT beacon, each of the plurality of sensors are embedded within the (RTU); and in which the RTU is manufactured is installed as an upgrade to a non-internet connected beacon to provide internet connectivity and telemetry collection for the non-internet connected beacon.

According to another embodiment of the IOT beacon, the RTU further includes a wireless transceiver to communicate with the remote centralized communication station via one of WiFi, 3G, 4G, 5G, GSM, or cellular communication.

According to another embodiment of the IOT beacon, the remote centralized communication station to identify the current failure condition at the IOT beacon includes: an analysis engine at the remote centralized communication station determining one or more of the following critical failure modes: determining the light source is emitting light below a minimum threshold; determining the light source has entered a fail-over mode; determining the light source is emitting no light in non-compliance with a specified operational mode; determining solar cells of the IOT beacon are outputting below a minimum threshold required to power the IOT beacon; determining a battery of the IOT beacon is outputting below a minimum threshold required to power the light source of the IOT beacon at or above a minimum threshold luminosity; and in which the remote centralized communication station is to initiate one or more alerts includes initiating an emergency alert for emergency servicing of the determined one or more critical failure modes at the IOT beacon.

According to another embodiment of the IOT beacon, the remote centralized communication station to identify the current failure condition at the IOT beacon includes: a prediction engine at the remote centralized communication station determining one or more of the following non-critical predicted failure modes: determining the light source is degrading at an unexpected rate; determining solar cells of the IOT beacon are outputting below a pre-determined standard or outputting a threshold amount less than other IOT beacons monitored by the remote centralized communication station; determining a battery of the IOT beacon is degrading at an unexpected rate; and in which the remote centralized communication station is to initiate one or more alerts includes initiating a non-critical maintenance notice, in which the notice specifies a maintenance time window for servicing the one or more non-critical failure modes at the IOT beacon.

According to another embodiment of the IOT beacon, the IOT beacon operates as one of a plurality of IOT beacons within a network of remote stations connected with the remote centralized communication station; in which each of the plurality of IOT beacons communicate with the remote centralized communication station via a public Internet; and in which the plurality of IOT beacons communicate with an application server at the remote centralized communication station through a Supervisory Control And Data Acquisition (SCADA) type network via the public Internet.

According to another embodiment of the IOT beacon, the remote centralized communication station provides a cloud-based smart beacon monitoring service having embodied therein an application server executing an analysis engine via a processor and a memory of the application server to perform the analysis of the collected telemetry data to identify current failure conditions and further in which the application server further executes a prediction engine via the processor and the memory of the application server to identify predicted failure conditions at the IOT beacon based on the analysis.

According to another embodiment of the IOT beacon, the remote centralized communication station is to initiate the one or more alerts includes the remote centralized communication station alerting users via one or more of: an SMS text message alert; an email alert; a maintenance prompt at an engineering station; a user alert at a User Interface for a user authenticated with the remote centralized communication station.

According to yet another embodiment, there is an Internet of Things (IOT) beacon, including: a light source 665; a Remote Transmission Unit (RTU) 627 to communicate with a remote centralized communication station over a network; a Radio Frequency (RF) sensor 626 to detect the presence of a flying drone or an Unmanned Arial Vehicle (UAV) within a threshold distance of the IOT beacon 601; a signal jammer 685 to generate a zone of interference around the IOT beacon to disrupt flight controls of the detected flying drone or UAV, for instance, by issuing radio waves or radio interference or noise within a same identified frequency band 641 within which the drone is identified as operating and communicating. According to such an embodiment, the RTU 627 is to further transmit collected telemetry data from RF sensor describing the presence of the flying drone or UAV to the remote centralized communication station over the network for analysis.

According to another embodiment of the IOT beacon, the signal jammer 685 to generate the zone of interference around the IOT beacon includes the signal jammer to emit one or more of: radio waves within a same band within which the RF sensor detected the flying drone or UAV, sonic waves, ultrasonic waves, or pulsed high-pressure air bursts.

According to another embodiment of the IOT beacon, the signal jammer 685 to generate the zone of interference around the IOT beacon causes the flying drone or UAV to retreat from a structure to which the IOT beacon is attached.

According to another embodiment of the IOT beacon, the signal jammer 685 to generate the zone of interference around the IOT beacon includes the signal jammer to generate a boundary around an asset, property, or structure to which the IOT beacon is attached; and in which the generated boundary creates a no-fly zone around the asset, property, or structure to which the IOT beacon is attached.

According to another embodiment, the IOT beacon further includes: a transceiver to emit an emergency signal notifying the detected the flying drone or UAV of the presence of an asset, property, or structure to which the IOT beacon is attached and notifying the flying drone or UAV of a no-fly zone around the asset, property, or structure to which the IOT beacon is attached.

According to another embodiment, the IOT beacon further includes: one or both of an optical sensor and an audio sensor to detect the presence of the flying drone or UAV; in which telemetry data collected from the optical sensor and/or audio sensor supplements the telemetry data from the RF sensor; and in which the collected telemetry data including data from the RF sensor and the optical sensor and/or audio sensor is transmitted by the RTU to the remote centralized communication station over the network for analysis.

According to yet another embodiment, there is an Internet of Things (IOT) beacon, including: a light source 665; a Remote Transmission Unit (RTU) 627 to communicate with a remote centralized communication station over a network; a Radio Frequency (RF) sensor 626 to detect the presence of a flying drone or an Unmanned Arial Vehicle (UAV) within a threshold distance of the IOT beacon; a transceiver 628 to transmit instructions to the detected flying drone or UAV to follow an intelligent flight path as specified by the IOT beacon, in which the intelligent flight path, when followed by the detected flying drone or UAV, prevents collision of the detected flying drone or UAV with an asset, property, or structure to which the IOT beacon is attached; and in which the RTU is to transmit collected telemetry data from RF sensor describing the presence of the flying drone or UAV to the remote centralized communication station over the network for analysis.

According to another embodiment of the IOT beacon, the IOT beacon receives the intelligent flight path specifications or other instructions 648 from the remote centralized communication station via the network; and in which the IOT beacon transmits the received intelligent flight path specifications to the flying drone or UAV via one or both of an infrared or an RF uni-directional communications protocol.

According to another embodiment of the IOT beacon, the transceiver of the IOT beacon is to further receive bi-directional communications from the flying drone or UAV requesting to authenticate with the IOT beacon as a security drone to operate in collaboration with the IOT beacon.

According to another embodiment, the IOT beacon further includes: a signal jammer to generate a zone of interference around the IOT beacon to disrupt flight controls of the detected flying drone or UAV when the detected flying drone or UAV crosses a boundary established by the IOT beacon around an asset, property, or structure to which the IOT beacon is attached or alternatively when the detected flying drone or UAV fails to traverse the intelligent flight path as specified by the IOT beacon pursuant to the instructions transmitted by the IOT beacon to the detected flying drone or UAV.

FIG. 6B illustrates a diagrammatic representation of a machine 600 in the exemplary form of a computer system, in accordance with one embodiment, within which a set of instructions, for causing the machine/computer system 600 to perform any one or more of the methodologies discussed herein, may be executed. In alternative embodiments, the machine may be connected (e.g., networked) to other machines in a Local Area Network (LAN), an intranet, an extranet, or the public Internet. The machine may operate in the capacity of a server or a client machine in a client-server network environment, as a peer machine in a peer-to-peer (or distributed) network environment, as a server or series of servers within an on-demand service environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 600 includes a processor 602, a main memory 604 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 618 (e.g., a persistent storage device including hard disk drives and a persistent database and local data store), which communicate with each other via a bus 630. Main memory 604 and its sub-elements are operable in conjunction with the processing logic 603 of the processor 602 as well as the alert policies 624, the collected telemetry data 623, and the prediction engine 625 which may execute via the processor 602 to perform the methodologies discussed herein.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 602 may also be one or more special-purpose processing devices such as an application specific integrated circuit (ASIC), a field programmable gate array (FPGA), a digital signal processor (DSP), network processor, or the like. Processor 602 is configured to execute the processing logic 603 for performing the operations and functionality which is discussed herein.

The computer system 600 may further include a network interface card 608. The computer system 600 also may include a user interface 610 (such as a video display unit, a liquid crystal display, etc.), an alphanumeric input device 612 (e.g., a keyboard), a cursor control device 614 (e.g., a mouse), and a signal generation device 616 (e.g., an integrated speaker). The computer system 600 may further include peripheral device 636 (e.g., wireless or wired communication devices, memory devices, storage devices, audio processing devices, video processing devices, etc.).

The secondary memory 618 may include a non-transitory machine-readable storage medium or a non-transitory computer readable storage medium or a non-transitory machine-accessible storage medium 631 on which is stored one or more sets of instructions (e.g., software 622) embodying any one or more of the methodologies or functions described herein. The software 622 may also reside, completely or at least partially, within the main memory 604 and/or within the processor 602 during execution thereof by the computer system 600, the main memory 604 and the processor 602 also constituting machine-readable storage media. The software 622 may further be transmitted or received over a network 620 via the network interface card 608.

Referring to FIGS. 7A-7C, a block diagram of a detailed sample architecture of a prediction engine is shown.

FIGS. 7A-7C create a continuous architecture diagram such that inputs from FIG. 7A may flow to FIG. 7B, inputs from FIG. 7B may flow to FIG. 7C, outputs from FIG. 7C may flow to FIG. 7B, and outputs from FIG. 7B may flow to FIG. 7A. Each block illustrated in FIGS. 7A-7C may represent a software, hardware or firmware component acting in coordination with a general purpose electronic device of the prediction engine. Additionally, peripheral components such as an email server and/or a data source may be included in FIGS. 7A-7C to provide reference as to the inputs and outputs of the prediction engine.

In particular, FIG. 7A illustrates a services platform that may include the presentation platform or user interface is described previously. As illustrated in FIG. 7A, the components 704-710 illustrate components of the prediction engine that handle the reception of environmental data (which, as discussed above, includes one or more portions of the telemetry or fault conditions or smart beacon state, etc.), the filtering of the environmental data, the context-refinement of the environmental data and the transmission of the filtered and context-refined environmental data to the environmental data queue 724, as illustrated in FIG. 7B.

Specifically, external environmental data adaptor 709 receives environmental data from the external environmental data source 703 (e.g., the database server 410 from FIG. 4) with such environmental data then being provided to the external environmental data adaptor. In one embodiment, the scheduler services 710 provides the received environmental data to the environmental data ingestion services 708 through the service API 704 according to predetermined time intervals. The service API 704 may present the environmental data to the environmental data ingestion services 708 in a singular format (e.g., in an extensible markup language (XML) file or a hypertext markup language (HTML) file) such that the environmental data ingestion services 708 may easily filter the received environmental data as the external environmental data source 703 may provide the environmental data to the external environmental data adaptor 709 in a plurality of formats due to the environmental data potentially being derived from a plurality of databases.

The environmental data ingestion service 708 may perform operations similar to the application server 425 depicted at FIG. 4 by determining whether received environmental data includes a significant change from the environmental data previously transmitted from the environmental data ingestion service 708 to the environmental detector service 707 and the environmental data queue 724 (via the data services API 720). The environmental data emergency detector service 707 may perform operations to determine whether a critical failure state exists, such as a beacon lamp being out or having entered a failover mode and thus subject to critical failure as no redundancy exists, for instance, by analyzing at least a subset of the environmental data to determine whether an emergency is occurring or is imminent based on one or more predefined rule sets.

Upon detecting an emergency, the environmental data emergency detector service 707 may generate a notification (e.g., SMS, email, prompting a message to an engineering station, etc.) and provide the notification to the environmental data context refinement service 706.

The notification may include the type of emergency detected, the one or more rules whose application triggered the detection of the emergency and/or one or more variables from the intelligent hardware sensors of the smart beacon and/or a sensor database available to the prediction engine. The environmental data context refinement service 706 may obtain particularized environmental data based on the notification generated by the environmental data emergency detector service 707 by applying one or more predefined rule sets to the environmental data.

Referring to FIG. 7B, data from one or more of the environmental data ingestion service 708, the environmental data emergency detector service 707 and/or the environmental data context refinement service 706 may be provided to the environmental data queue 724, and/or a NoSQL database 727 by way of the data services API 720. The data services API 720 may utilize a short message service (SMS) plugin 723 to pass the data to the environmental data queue and a NoSQL plugin, and data obtained from the RDMS 726, to pass the data to the NoSQL database 727, each of which are interfaced and work in further conjunction with the RDBMS 722 and NoSQL 721 modules of the data services API 720.

Referring to FIG. 7C, the environmental data queue passes the data stored therein to the intuition generator 743 by way of the environmental data receiver 741 and optionally through the contingency selector 742. Upon generating an intuition, as discussed above, the intuition generator 743 provides the intuition to the notification queue 725 of FIG. 7B. The intuition is then passed through the data services API 720 to the environmental notification service 705 of FIG. 7A. The environmental notification service 705 may provide the intuition to one or more users via an email server 701 and/or an SMS server 702.

As discussed above, a UI may be generated, in this embodiment by the environmental notification service 705, to present the intuition as a UI to one or more users 170.

Referring to FIG. 7A, the components 712-717 illustrate components of the prediction engine that handle the reception of sensor data, the filtering of the sensor data, the context-refinement of the sensor data and the transmission of the filtered and context-refined sensor data to the sensor data queue 733, as illustrated in FIG. 7B. A second data services API 728 provides JMS plugin 730 and NoSQL 729 module, each operable in conjunction with the sensor data queue 733, alert notification queue 732, and ingestion management queue 731. In one embodiment, a historian database 711 provides sensor data to a historian database adaptor 716 which, through the scheduler services 717 as predetermined time intervals, provides the sensor data to the service API 714. The service API 714 may present the sensor data to the sensor data ingestion services 715 in a singular format such that the sensor data ingestion services 715 may easily filter the received sensor data as the historian database 711 may provide the sensor data to the historian database adaptor 716 in a plurality of formats.

The sensor data ingestion service 715 may determine whether the received sensor data includes a significant change from the sensor data previously transmitted from the smart beacon's intelligent hardware sensors or from the sensor data ingestion service 715 to the sensor data queue 733. The sensor data ingestion service 715 may determine whether a significant change exists based on comparing the change between the current sensor data and the most recently sensor data transferred to the sensor data queue 733 to one or more predetermined thresholds (e.g., based on the percentage of change of one or more variables).

Referring to FIG. 7B, sensor data may be provided to the sensor data queue 733 by way of the data services API 728 using, in one embodiment, an SMS plugin based on the type of queue comprising the sensor data queue 733. Additionally, the sensor data may be provided to a NoSQL database 740 and subsequently be passed on to the data integration 735 and data virtualization 734 components prior to being passed to a display or User Interface presentation platform as illustrated in FIG. 7A.

Referring to FIG. 7C, the sensor data queue passes the sensor data stored therein to a prediction engine such that the sensor data receiver 745 receives the sensor data as passed to the pattern detector 744. The pattern detector 744 may utilize one or more predefined rule sets, algorithms, functions and/or equations such as any linear or nonlinear functions, quadratic equations, trigonometric functions (e.g., sine and cosine), polynomial equations or the like in order to determine whether a pattern is present in the sensor data. The pattern detector 744 may analyze the current sensor data in light of previous sensor data similarly stored in the sensor data queue. The pattern detector 744 may provide results of the pattern detection to an alert notification generator and/or a sensor data collection logic 745.

The combination of one or more of the outputs of the pattern detector 744, the alert notification generator 746 and the sensor data collection logic 745 may be referred to as an insight or a prediction. The output of the alert notification generator 746 and the output of the sensor data collection logic 745 may be provided to the alert notification queue 732 and the ingestion management queue 731, respectively, as illustrated in FIG. 7B. The output of the alert notification generator 746 and the output of the sensor data collection logic 745 (cumulatively, an insight or prediction) may then be passed to event notification service 713 and the sensor context refinement service 712 using the data services API 728. The event notification service 713 may provide the insight to the email server 701 and/or the SMS server 702 which operate in conjunction with the presentation layer 718 and dashboards 719. As discussed above, a UI may be generated, in this embodiment by the event notification service 713, to present the insight as a UI to one or more users.

Referring to FIG. 8, a flowchart of an exemplary process for predicting failure within a system by the prediction engine in order to generate an insight or a prediction is shown.

Each block illustrated in FIG. 8 represents an operation performed in the method 800 of predicting failure within a system is shown. The method 800 illustrates the process through which the prediction engine predicts a point of failure within a system (e.g., one or more pieces of equipment, wherein when the system includes two or more pieces of equipment, the two or more pieces may operate in a dependent manner or may operate in an independent manner). Upon predicting one or more failure points, the prediction engine may then generate an insight or a prediction, such as a prediction that a beacon lamp will drop below a threshold luminosity or fail entirely within a given time period.

As an overview, each reading provided by a sensor of a sensor network formed by the collection of smart beacons or a sensor database at a particular time may be interpreted as a coordinate in a multidimensional space. For example, in a smart beacon, telemetry parameters such as luminosity, battery voltage, lamp voltage consumption, and operating temperature, at a first time via four sensors may provide a coordinate in multidimensional space corresponding to the reading of the four sensors.

The orthogonal distance between this multidimensional coordinate and a multidimensional surface of previously known failure points (e.g., generated by surface, or curve, fitting techniques), may be determined. A second multidimensional coordinate may then be determined at a second time from the same four sensors. Upon determining the second multidimensional coordinate, the orthogonal distance between the second multidimensional coordinate and the multidimensional surface fitting of the previously known failure points may be determined. The orthogonal distances may then be compared to determine whether the orthogonal distance between the multidimensional coordinates is approaching the multidimensional surface fitting of the previously known failure points. The prediction engine may alert one or more users based upon the comparison of the orthogonal distances. In the various embodiments, more or less than the four sensors of this particular example may be used.

At time T1, each of the sensors S1 to SN are read to determine a first coordinate point, CSi1, wherein CSi1=(S1T1, S2T1, . . . , SNT1) (block 801).

At block 802, the prediction engine determines the orthogonal distance from CSi1 to an extrapolated multidimensional surface of previously known failure points (referred to hereinafter as the “degradation measure Ti”).

A failure point may be construed as a multidimensional coordinate corresponding to a point of failure of the system or equipment that was previously known, in other words, the sensor data when a failure previously occurred. Herein, the multidimensional surface fitting of previously known failure points may be done periodically by the prediction engine prior to the start of the method 800, the prediction engine may be initially configured with a multidimensional surface based on previously known failure points and/or the prediction engine may receive updates to the multidimensional surface based on new failure points from a network administrator, or the like, over a network, such as the SCADA network 405 of FIG. 4.

At time T2, each of the sensors Si to SN are read to determine a second coordinate point, CSi2, wherein CSi2=(S1T2, S2T2, . . . , SNT2) (block 803).

At block 804, the prediction engine determines the orthogonal distance from CSi2 to the extrapolated multidimensional surface of the previously known failure points (referred to hereinafter as the “degradation measure T2”).

At block 805, the prediction engine determines whether the difference between the degradation measure T1 and the degradation measure T2 is greater than a predetermined threshold, wherein the predetermined threshold may be dependent on the orthogonal distance of CSi1 to the extrapolated multidimensional surface of the previously known failure points. For example, the predetermined threshold used in block 805 may be a first value when a first orthogonal distance between CSi1 and the extrapolated multidimensional surface but would be a second, larger value orthogonal distance between CSi1 and the extrapolated multidimensional surface is a second value larger than the first value. In other words, in one embodiment, the closer CSi1 is to the extrapolated multidimensional surface, the smaller the predetermined threshold may be.

When the difference between the degradation measure T1 and the degradation measure T2 is not greater than a predetermined threshold (no at block 805), the method 800 proceeds to block 806 to repeat the method for the next measure, thus causing the method 800 to start again in order to compare the degradation measure T2 with a degradation measure T3 based on the readings of the sensor network and/or the sensor database at time T3, wherein time T3 is a time later than time T2.

When the difference between the degradation measure T1 and the degradation measure T2 is greater than a predetermined threshold (yes at block 805), the prediction engine calculates the speed of degradation (block 807). The speed of degradation is the change in degradation (difference between the degradation measure T1 and the degradation measure T2) divided by the time elapsed from T1 to T2. The speed of degradation is set forth in the equation below, where:

$$Speed of degradation = \frac{degradation measure T 1 - degradation measure T 2}{T 2 - T1} .$$

At block 808, the prediction engine calculates the prediction of the next failure point. Calculating the prediction of the next failure point is done by dividing the current degradation measure (e.g., the latest degradation measure, herein being the degradation measure T2) by the speed of degradation, which is set forth in the equation below, where:

$$Prediction of next failure point = \frac{degradation measure T 2}{speed of degradation} .$$

Upon calculating the prediction of the next failure point, the prediction is presented to the user(s) at block 809. In addition to the prediction, the prediction engine may also present the user(s) with the sensor data used in the prediction.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as are apparent to those skilled in the art. Therefore, the scope of the appended claims are to be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. An Internet of Things (IOT) beacon, comprising:
a light source;
a Remote Transmission Unit (RTU) to communicate with a remote centralized communication station over a network;
a plurality of sensors, each to collect telemetry data at the IOT beacon;
wherein the RTU is to transmit the collected telemetry data from the plurality of sensors to the remote centralized communication station over the network for analysis;
wherein the remote centralized communication station is to identify a current or predicted failure condition at the IOT beacon based on the analysis of the collected telemetry data from the plurality of sensors; and
wherein the remote centralized communication station is to initiate one or more alerts to have service personnel perform maintenance to correct the identified current or predicted failure condition at the IOT beacon.

2. The IOT beacon of claim 1, wherein the light source emits light within an aviation warning and collision avoidance system for aircraft and unmanned aerial vehicles.

3. The IOT beacon of claim 1, wherein the IOT beacon is attached to one of:
a communication tower;
a high-rise building;
an antenna;
a bridge;
a geological feature.

4. The IOT beacon of claim 1, wherein the plurality of sensors to collect telemetry data at the IOT beacon include one or more of:
a luminosity sensor to measure light output from the light source;
a battery voltage sensor;
a solar panel output voltage sensor;
a weather sensor;
a Radio Frequency (RF) sensor to count each time a drone or Unmanned Arial Vehicle (UAV) comes within range of the RF sensor of the IOT beacon;
a thermometer to measure ambient temperature;
a sunlight intensity sensor; and
an embedded encryption and security key to enable encrypted security and secure authentication between the IOT beacon and the centralized communication station prior to the IOT beacon transmitting the telemetry data to the centralized communication station.

5. The IOT beacon of claim 1:
wherein each of the plurality of sensors are embedded within the (RTU); and
wherein the RTU is manufactured is installed as an upgrade to a non-internet connected beacon to provide internet connectivity and telemetry collection for the non-internet connected beacon.

6. The IOT beacon of claim 1, wherein the RTU further comprises a wireless transceiver to communicate with the remote centralized communication station via one of WiFi, 3G, 4G, 5G, GSM, or cellular communication.

7. The IOT beacon of claim 1, wherein the remote centralized communication station to identify the current failure condition at the IOT beacon comprises:
an analysis engine at the remote centralized communication station determining one or more of the following critical failure modes:
determining the light source is emitting light below a minimum threshold;
determining the light source has entered a fail-over mode;
determining the light source is emitting no light in non-compliance with a specified operational mode;
determining solar cells of the IOT beacon are outputting below a minimum threshold required to power the IOT beacon;
determining a battery of the IOT beacon is outputting below a minimum threshold required to power the light source of the IOT beacon at or above a minimum threshold luminosity; and
wherein the remote centralized communication station is to initiate one or more alerts comprises initiating an emergency alert for emergency servicing of the determined one or more critical failure modes at the IOT beacon.

8. The IOT beacon of claim 1, wherein the remote centralized communication station to identify the current failure condition at the IOT beacon comprises:
a prediction engine at the remote centralized communication station determining one or more of the following non-critical predicted failure modes:
determining the light source is degrading at an unexpected rate;
determining solar cells of the IOT beacon are outputting below a pre-determined standard or outputting a threshold amount less than other IOT beacons monitored by the remote centralized communication station;
determining a battery of the IOT beacon is degrading at an unexpected rate; and
wherein the remote centralized communication station is to initiate one or more alerts comprises initiating a non-critical maintenance notice, wherein the notice specifies a maintenance time window for servicing the one or more non-critical failure modes at the IOT beacon.

9. The IOT beacon of claim 1:
wherein the IOT beacon operates as one of a plurality of IOT beacons within a network of remote stations connected with the remote centralized communication station;
wherein each of the plurality of IOT beacons communicate with the remote centralized communication station via a public Internet; and
wherein the plurality of IOT beacons communicate with an application server at the remote centralized communication station through a Supervisory Control And Data Acquisition (SCADA) type network via the public Internet.

10. The IOT beacon of claim 1, wherein the remote centralized communication station provides a cloud-based smart beacon monitoring service having embodied therein an application server executing an analysis engine via a processor and a memory of the application server to perform the analysis of the collected telemetry data to identify current failure conditions and further wherein the application server further executes a prediction engine via the processor and the memory of the application server to identify predicted failure conditions at the IOT beacon based on the analysis.

11. The IOT beacon of claim 1, wherein the remote centralized communication station is to initiate the one or more alerts comprises the remote centralized communication station alerting users via one or more of:
an SMS text message alert;
an email alert;
a maintenance prompt at an engineering station;
a user alert at a User Interface for a user authenticated with the remote centralized communication station.

12. An Internet of Things (IOT) beacon, comprising:
a light source;
a Remote Transmission Unit (RTU) to communicate with a remote centralized communication station over a network;
a Radio Frequency (RF) sensor to detect the presence of a flying drone or an Unmanned Arial Vehicle (UAV) within a threshold distance of the IOT beacon;
a signal jammer to generate a zone of interference around the IOT beacon to disrupt flight controls of the detected flying drone or UAV; and
wherein the RTU is to transmit collected telemetry data from RF sensor describing the presence of the flying drone or UAV to the remote centralized communication station over the network for analysis.

13. The IOT beacon of claim 12, wherein the signal jammer to generate the zone of interference around the IOT beacon comprises the signal jammer to emit one or more of: radio waves within a same band within which the RF sensor detected the flying drone or UAV, sonic waves, ultrasonic waves, or pulsed high pressure air bursts.

14. The IOT beacon of claim 12, wherein the signal jammer to generate the zone of interference around the IOT beacon causes the flying drone or UAV to retreat from a structure to which the IOT beacon is attached.

15. The IOT beacon of claim 12:
wherein the signal jammer to generate the zone of interference around the IOT beacon comprises the signal jammer to generate a boundary around an asset, property, or structure to which the IOT beacon is attached; and
wherein the generated boundary creates a no-fly zone around the asset, property, or structure to which the IOT beacon is attached.

16. The IOT beacon of claim 12, further comprising:
a transceiver to emit an emergency signal notifying the detected the flying drone or UAV of the presence of an asset, property, or structure to which the IOT beacon is attached and notifying the flying drone or UAV of a no-fly zone around the asset, property, or structure to which the IOT beacon is attached.

17. The IOT beacon of claim 12, further comprising:
one or both of an optical sensor and an audio sensor to detect the presence of the flying drone or UAV;
wherein telemetry data collected from the optical sensor and/or audio sensor supplements the telemetry data from the RF sensor; and
wherein the collected telemetry data including data from the RF sensor and the optical sensor and/or audio sensor is transmitted by the RTU to the remote centralized communication station over the network for analysis.

18. An Internet of Things (IOT) beacon, comprising:
a light source;
a Remote Transmission Unit (RTU) to communicate with a remote centralized communication station over a network;
a Radio Frequency (RF) sensor to detect the presence of a flying drone or an Unmanned Arial Vehicle (UAV) within a threshold distance of the IOT beacon;
a transceiver to transmit instructions to the detected flying drone or UAV to follow an intelligent flight path as specified by the IOT beacon, wherein the intelligent flight path, when followed by the detected flying drone or UAV, prevents collision of the detected flying drone or UAV with an asset, property, or structure to which the IOT beacon is attached; and
wherein the RTU is to transmit collected telemetry data from RF sensor describing the presence of the flying drone or UAV to the remote centralized communication station over the network for analysis.

19. The IOT beacon of claim 18:
wherein the IOT beacon receives the intelligent flight path specifications from the remote centralized communication station via the network; and
wherein the IOT beacon transmits the received intelligent flight path specifications to the flying drone or UAV via one or both of an infrared or an RF uni-directional communications protocol.

20. The IOT beacon of claim 18:
wherein the transceiver of the IOT beacon is to further receive bi-directional communications from the flying drone or UAV requesting to authenticate with the IOT beacon as a security drone to operate in collaboration with the IOT beacon.

21. The IOT beacon of claim 18, further comprising:
a signal jammer to generate a zone of interference around the IOT beacon to disrupt flight controls of the detected flying drone or UAV when the detected flying drone or UAV crosses a boundary established by the IOT beacon around an asset, property, or structure to which the IOT beacon is attached or alternatively when the detected flying drone or UAV fails to traverse the intelligent flight path as specified by the IOT beacon pursuant to the instructions transmitted by the IOT beacon to the detected flying drone or UAV.
